(19) United States
(12) Patent Application Publication
(10) Pub. No.: US 2008/0030662 A1
(43) Pub. Date: Feb. 7, 2008

(54) Liquid crystal display device

(75) Inventor: Koichi Igeta, Chiba (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/822,223

(22) Filed: Jul. 3, 2007

(30) Foreign Application Priority Data
Aug. 2, 2006 (JP) 2006-210976

(51) Int. Cl. G02F 1/1335

(52) U.S. Cl. 349/114

(57) ABSTRACT

In a liquid crystal display panel having pixels each of which is constituted of a transmissive display region and a reflective display region, a numerical aperture is enhanced by increasing the transmissivity of the transmissive display region or the reflectance of the reflective display region. In a liquid crystal display device which has a display region constituted of a plurality of pixels arranged two-dimensionally in the extending direction of scanning signal lines and in the extending direction of video signal lines, the display region alternately arranges a first pixel row which is formed by arranging a plurality of first pixels each of which has only a transmissive display region in the extending direction of the scanning signal lines and a second pixel row which is formed by arranging a plurality of second pixels each of which has a reflective display region and a transmissive display region in the extending direction of the scanning signal lines in the extending direction of video signal lines.

The present application claims priority from Japanese application JP2006-210976 filed on Aug. 2, 2006, the content of which is hereby incorporated by reference into this application.

### BACKGROUND OF THE INVENTION

1. Field of the Invention

The present invention relates to a liquid crystal display panel, and more particularly to a technique which is effectively applicable to a transflective liquid crystal display device.

2. Description of the Related Art

Conventionally, as a display device which displays videos or images, there has been known a liquid crystal display device which includes a liquid crystal display panel which seals a liquid crystal material between a pair of substrates. The liquid crystal display panel is an optical element which controls brightness of light which is radiated to a viewer's side, that is, contrast by changing the orientation of liquid crystal molecules corresponding to a magnitude of an electric field applied to the liquid crystal material sealed between the pair of substrates thus changing a rotatory polarization state and a phase difference of light which passes through the liquid crystal material. Further, the liquid crystal display panel is roughly classified into three kinds of liquid crystal display panels, that is, a transmissive liquid crystal display panel, a reflective liquid crystal display panel and a transflective liquid crystal display panel in view of a method which radiates light to the viewer's side.

The transmissive liquid crystal display panel is a display panel which allows light incident on the liquid crystal display panel from behind the liquid crystal display panel as viewed from the viewer and allows the light to be radiated to the viewer's side. The transmissive liquid crystal display panel is suitable as a display panel of a liquid crystal display device used indoors such as a television receiver set, for example.

The reflective liquid crystal display panel is a panel which reflects light incident on the liquid crystal display panel from a front side of the liquid crystal display panel as viewed from the viewer and radiates the light to the viewer's side. The reflective liquid crystal display panel is suitable as a display panel of the liquid crystal display device used outdoors such as a display of a shop, for example.

The transflective liquid crystal display panel is a display panel which includes a transmissive display region which allows light incident on the liquid crystal display panel from behind the liquid crystal display panel as viewed from the viewer and allows the light to be radiated to the viewer's side and a reflective display region which reflects light incident on the liquid crystal display panel from a front side of the liquid crystal display panel as viewed from the viewer and radiates the light to the viewer's side. For example, the transflective liquid crystal display panel is suitable as a display panel of a liquid crystal display device which is used indoors as well as outdoors such as a mobile phone terminal or a PDA (Personal Digital Assistant), for example.

Further, the transflective liquid crystal display panel is a display panel in which one pixel (one dot) of a displayed video or image is constituted of the transmissive display region and the reflective display region. In general, every pixel within a display region of the liquid crystal display panel is constituted of the transmissive display region and the reflective display region.

Further, with respect to the liquid crystal display devices of recent years, for example, there has been proposed a display device which divides a display region of a liquid crystal display panel in two, wherein one display region is used as a transflective or reflective display region and another display region is used as a transmissive display region (for example, see patent document 1).

Patent Document 1: JP-A-2002-55337

### SUMMARY OF THE INVENTION

The above-mentioned transflective liquid crystal display panel used as the display of the mobile phone terminal or the like is configured such that every pixel within the display region of the liquid crystal display panel is constituted of the transmissive display region and the reflective display region. Further, recently, a transflective liquid crystal display panel which can cope with a color display is popularly used. For example, in case of a color liquid crystal display panel adopting an RGB method, one pixel (1 dot) is constituted of a sub pixel displaying R (red), ad sub pixel displaying G (green) and a sub pixel displaying B (blue). In such a transflective color liquid crystal display panel, the pixels in the display region are configured as shown in FIG. 20 and FIG. 21. FIG. 20 is a schematic plan view showing the constitution of the pixels around a corner portion of the display region in the conventional transflective color liquid crystal display panel, and FIG. 21 is a schematic cross-sectional view taken along a line F-F′ in FIG. 20.

To observe the conventional transflective color liquid crystal display panel from a display screen side, for example, as shown in FIG. 20, quadrangular pixels each of which has a size LX in the x direction and a size LY in the y direction are arranged two-dimensionally in the x direction as well as in the y direction. Here, one pixel region includes six display regions consisting of a transmissive display region WT and a reflective display region WR of the sub pixel displaying R (red), a transmissive display region WT and a reflective display region WR of the sub pixel displaying G (green) and a transmissive display region WT and a reflective display region WR of the sub pixel displaying B (blue), for example.

Here, the transmissive display region WT and the reflective display region WR of one color is formed as one sub pixel. For example, the sub pixel displaying G (green), as shown in FIG. 21, forms a step forming layer MR in the reflective display region WR such that a distance between a pixel electrode PX and a common electrode CT in the reflective display region WR becomes shorter than a distance between the pixel electrode PX and the common electrode CT in the transmissive display region WT. That is, a thickness dr of a liquid crystal layer LC in the reflective display region WR is set smaller than a thickness dt of the liquid crystal layer LC in the transmissive display region WT. Here, a ratio between the thickness dt of the liquid crystal layer LC in the transmissive display region WT and the thickness dr of the liquid crystal layer LC in the reflective display region WR is set to approximately 2:1 thus making optical path lengths (optical phase differences) of the respective regions substantially agree with each other. Further, the reflective display region WR forms a reflective electrode RE on the pixel electrode PX, for example.

Here, in case of the transflective color liquid crystal display panel having the constitution shown in FIG. 20 and FIG. 21, a stepped portion is formed in the boundary portion between the transmissive display region WT and the reflective display region WR in one sub pixel, and the orientation of the liquid crystal molecules is disturbed in the stepped portion. In the same manner, also between two neighboring pixels in the y direction, a stepped portion is formed in a boundary portion between the transmissive display region of one pixel and the reflective display region of another pixel, and the orientation of the liquid crystal molecule is disturbed in the stepped portion. Accordingly, when the sub pixel performs display with a lowest grayscale (brightness) as in the case of a black display, for example, there arises a drawback that leaking of light occurs at the stepped portion. To cope with such a drawback, in the conventional transflective color liquid crystal display panel, for example, as shown in FIG. 20 and FIG. 21, a light blocking film which is referred to as a black matrix BM is provided at a position where the black matrix BM overlaps the stepped portion as viewed in a plan view thus preventing leaking of light.

However, with respect to the conventional transflective color liquid crystal display panel, for example, as shown in FIG. 21, when the step forming layer MR is formed on the TFT substrate 1 and the black matrix BM is formed on the counter substrate 2, by taking the positional displacement of two substrates or the like into consideration, a width of the black matrix BM is set larger than a width of a region in which light actually leaks due to the stepped portion.

The width of the black matrix BM does not depend on the size of the pixel and is set to an approximately fixed value due to the accuracy of alignment of the above-mentioned two substrates or sizes of scanning signal lines GL or video signal lines formed on the TFT substrate 1. Accordingly, for example, when the size of one pixel becomes small, a rate of the region in which the light is blocked by the black matrix BM with respect to the size of the pixel is increased and hence, a numerical aperture is lowered thus giving rise to a drawback that the transmissivity of the transmissive display region WT and the reflectance of the reflective display region WR become small.

It is an advantage of the present invention to provide, in a liquid crystal display panel having pixels each of which is constituted of a transmissive display region and a reflective display region, a technique which can increase the transmissivity of the transmissive display region and the reflectance of the reflective display region while preventing lowering of a numerical aperture.

The above-mentioned and other advantages and novel features of the present invention will become apparent from the description of this specification and attached drawings.

To briefly explain the summary of typical inventions among the inventions disclosed in this specification, they are as follows.

(1) The present invention is directed to a liquid crystal display device including a liquid crystal display panel which seals a liquid crystal material between a pair of substrates, the liquid crystal display panel having a display region which is constituted of a plurality of pixels arranged two-dimensionally in the extending direction of scanning signal lines and in the extending direction of video signal lines, wherein

the display region of the liquid crystal display panel alternately arranges a first pixel row and a second pixel row thereon in the extending direction of the video signal lines, the first pixel row arranging a plurality of first pixels each of which includes only a transmissive display region which radiates light incident on the liquid crystal display panel from a back side of the liquid crystal display panel as viewed from a viewer to a viewer side in parallel in the extending direction of the scanning signal lines, and the second pixel row arranging a plurality of second pixels each of which includes a reflective display region which radiates light incident on the liquid crystal display panel from a front side of the liquid crystal display panel and the transmissive display region in parallel in the extending direction of the scanning signal lines.

(2) In a liquid crystal display device having the constitution (1), the second pixel is configured such that the reflective display region and the transmissive display region are arranged in parallel in the extending direction of the video signal lines.

(3) In a liquid crystal display device having the constitution (1) or (2), a size of the second pixel in the extending direction of the video signal lines is larger than a size of the first pixel in the extending direction of the video signal lines.

(4) In a liquid crystal display device having any one of constitutions (1) to (3), an area of the transmissive display region of the first pixel is approximately equal to an area of the transmissive display region of the second pixel.

(5) In a liquid crystal display device having the constitution (1) or (2), a size of the second pixel in the extending direction of the video signal lines is equal to a size of the first pixel in the direction of the video signal lines.

(6) In a liquid crystal display device having the constitution (1), (2) or (5), an area of the transmissive display region of the first pixel differs from an area of the transmissive display region of the second pixel.

(7) In a liquid crystal display device having any one of constitutions (1) to (6), a thickness of the liquid crystal material in the reflective display region is smaller than a thickness of the liquid crystal material in the transmissive display region.

(8) In a liquid crystal display device having any one of constitutions (1) to (7), the liquid crystal display panel includes the scanning signal lines, the video signal lines, and pixel electrodes which are arranged with respect to the plurality of respective pixels on one substrate out of the pair of substrates, the pixel electrode includes a region which overlaps the scanning signal line as viewed in a plan view, and an area of the region where the pixel electrode overlaps the scanning signal line arranged with respect to the first pixel and an area of the region where the pixel electrode overlaps the scanning signal line arranged with respect to the second pixel differ from each other.

(9) In a liquid crystal display device having any one of constitutions (1) to (7), the liquid crystal display panel includes the scanning signal lines, the video signal lines, pixel electrodes which are arranged with respect to the plurality of respective pixels, and holding capacitance lines which are arranged in parallel to the scanning signal lines on one substrate out of the pair of substrates, the pixel electrode includes a region which overlaps the holding capacitance line as viewed in a plan view, and an area of the region where the pixel electrode overlaps the holding capacitance line arranged with respect to the first pixel and an area of the region where the pixel electrode overlaps the holding capacitance line arranged with respect to the second pixel differ from each other.

(10) In a liquid crystal display device having any one of constitutions (1) to (9), a signal of positive polarity and a signal of negative polarity with respect to a potential of a common electrode are alternately applied to the pixel electrodes of respective pixels of the liquid crystal display panel for every other preset number of frames,

the signal having the same polarity as the polarity with respect to the potential of the common electrode is applied to the pixel electrodes of the respective pixels of two neighboring pixel rows in one frame, and

the polarity of the signal which is applied to the pixel electrodes of respective pixels of two pixel rows with respect to the potential of the common electrode is a polarity opposite to polarity of a signal which is applied to the pixel electrodes of respective pixels of two other pixel rows adjacent to two pixel rows with respect to the potential of the common electrode.

(11) The present invention is directed to a liquid crystal display device including a liquid crystal display panel which seals a liquid crystal material between a pair of substrates, the liquid crystal display panel having a display region which is constituted of a plurality of pixels arranged two-dimensionally in the extending direction of scanning signal lines and in the extending direction of video signal lines, wherein

the display region of the liquid crystal display panel is configured such that a plurality of pixel rows each of which arranges a first pixel having only a transmissive display region and a second pixel having a reflective display region and a transmissive display region alternately in parallel in the extending direction of the scanning signal lines is arranged in the extending direction of the video signal lines.

(12) In a liquid crystal display device having the constitution (11), the plurality of pixels which is arranged in parallel in the extending direction of the video signal lines in the display region of the liquid crystal display panel is constituted of only the first pixel or only the second pixel which is arranged in parallel.

(13) In a liquid crystal display device having the constitution (11), the plurality of pixels which is arranged in parallel in the extending direction of the video signal lines in the display region of the liquid crystal display panel is constituted of the first pixel and the second pixel which are alternatively arranged in parallel with each other.

(14) In a liquid crystal display device having any one of the constitutions (11) to (13), the second pixel is configured such that the reflective display region and the transmissive display region are arranged in parallel in the extending direction of the video signal lines.

(15) In a liquid crystal display device having any one of the constitutions (11) to (14), a thickness of the liquid crystal material in the reflective display region is smaller than a thickness of the liquid crystal material in the transmissive display region.

(16) In a liquid crystal display device having any one of the constitutions (11) to (15), the liquid crystal display panel includes the scanning signal lines, the video signal lines, and pixel electrodes which are arranged with respect to the plurality of respective pixels on one substrate out of the pair of substrates, the pixel electrode includes a region which overlaps the scanning signal line as viewed in a plan view, and an area of the region where the pixel electrode overlaps the scanning signal line arranged with respect to the first pixel and an area of the region where the pixel electrode overlaps the scanning signal line arranged with respect to the second pixel differ from each other.

(17) In a liquid crystal display device having any one of the constitutions (11) to (15), the liquid crystal display panel includes the scanning signal lines, the video signal lines, pixel electrodes which are arranged with respect to the plurality of respective pixels, and holding capacitance lines which are arranged in parallel to the scanning signal lines on one substrate out of the pair of substrates, the pixel electrode includes a region which overlaps the holding capacitance line as viewed in a plan view, and an area of the region where the pixel electrode overlaps the holding capacitance line arranged with respect to the first pixel and an area of the region where the pixel electrode overlaps the holding capacitance line arranged with respect to the second pixel differ from each other.

According to the present invention, transmissivity of the transmissive display region or reflectance of the reflective display region can be enhanced thus acquiring the liquid crystal display device having a high numerical aperture.

In the liquid crystal display device of the present invention, for example, the first pixel row which arranges the plurality of first pixels each of which includes only the transmissive display region in parallel in the extending direction of the scanning signal lines, and the second pixel row which arranges the plurality of second pixels each of which includes the reflective display region and the transmissive display region in parallel in the extending direction of the scanning signal line are alternately arranged in the extending direction of the video signal lines. Due to such a constitution, it is possible to reduce a boundary between the transmissive display region and the reflective display region whereby a numerical aperture can be increased. Accordingly, for example, when the transmissivity of all transmissive display regions with respect to the display region of the liquid crystal display panel is set to the corresponding transmissivity of the conventional liquid crystal display panel, it is possible to increase the reflectance of all reflective display regions with respect to the display region of the liquid crystal display panel compared to the corresponding reflectance of the conventional liquid crystal display panel. On the other hand, when the reflectance of all reflective display regions with respect to the display region of the liquid crystal display panel is set to the corresponding reflectance of the conventional liquid crystal display panel, it is possible to increase the transmissivity of all transmissive display regions with respect to the display region of the liquid crystal display panel compared to the corresponding transmissivity of the conventional liquid crystal display panel.

Here, it is desirable that the second pixel is configured such that the reflective display region and the transmissive display region are arranged in parallel in the extending direction of the video signal lines.

Further, a size of the second pixel in the extending direction of the video signal lines may be larger than a size of the first pixel in the extending direction of the video signal lines and a size of the second pixel in the extending direction of the video signal lines may be equal to a size of the first pixel in the extending direction of the video signal lines.

Further, in the liquid crystal display device of the present invention, although the second pixel may be constituted of two kinds of display regions constituted of the reflective display region and the transmissive display region, particularly, it is possible to obtain a high advantageous effect by setting the thickness of the liquid crystal material in the reflective display regions smaller than the thickness of the liquid crystal material in the transmissive display regions.

Further, the liquid crystal display device of the present invention includes the first pixels each of which has only the transmissive display region and the second pixels each of which has the reflective display region and the transmissive display region, and the first pixel and the second pixel differ from each other in a shape of the pixel electrode. Accordingly, in the liquid crystal display device of the present invention, it is desirable to set the pixel capacitances of the first pixel and the second pixel to a fixed value by changing holding capacitance of the first pixel and the holding capacitance of the second pixel. When the holding capacitances of the first pixel and the second pixel are formed in a region where the pixel electrode and the scanning signal line overlap each other in a plan view, the holding capacitances can be changed by changing an area of the overlapped region. Further, when the holding capacitance lines are arranged in parallel to the scanning signal lines and the holding capacitances of the first pixel and the second pixel are formed in the region where the pixel electrode and the holding capacitance line overlap each other in a plan view, it is possible to change the holding capacitance by changing an area of the overlapped region.

Further, in the liquid crystal display device, in general, when signals are applied to the pixel electrode of respective pixels of the liquid crystal display panel, a signal of positive polarity and a signal of negative polarity with respect to a potential of the common electrode are alternately applied to the pixel electrodes of respective pixels for every other preset number of frames. Accordingly, in the liquid crystal display device of the present invention, it is desirable to adopt a so-called 2-line inversion driving in which the signal having the same polarity as the polarity with respect to the potential of the common electrode is applied to the pixel electrodes of the respective pixels of two neighboring pixel rows in one frame, and the signal which is applied to the pixel electrodes of respective pixels of two pixel rows and the signal which is applied to the pixel electrodes of respective pixels of two other pixel rows adjacent to two pixel rows are signals which are opposite in polarity to each other with respect to the potential of the common electrode. Due to such a constitution, it is possible to reduce flickers and image retention which are generated when the polarity of the signal which is applied to each pixel electrode is inverted.

Further, in the liquid crystal display device of the present invention, for example, the plurality of pixel rows in which the first pixels and the second pixels are arranged alternately in the extending direction of the scanning signal lines may be arranged in the extending direction of the video signal lines. Here, in the display region of the liquid crystal display panel, the plurality of pixels which are arranged in the extending direction of the video signal lines may be configured such that the only the first pixels or only the second pixels may be arranged or the first pixels and the second pixels may be arranged alternately.

Also in this case, it is desirable that the second pixel is configured such that the reflective display region and the transmissive display region are arranged in parallel in the extending direction of the video signal lines.

Also in this case, although the second pixel may be constituted of two kinds of display regions constituted of the reflective display region and the transmissive display region, particularly, it is possible to obtain a high advantageous effect by setting the thickness of the liquid crystal material in the reflective display regions smaller than the thickness of the liquid crystal material in the transmissive display regions.

Also in this case, it is desirable to set the pixel capacitances of the first pixel and the second pixel to a fixed value by changing holding capacitance of the first pixel and the holding capacitance of the second pixel. When the holding capacitances of the first pixel and the second pixel are formed in a region where the pixel electrode and the scanning signal line overlap each other in a plan view, the holding capacitances can be changed by changing an area of the overlapped region. Further, when the holding capacitance lines are arranged in parallel to the scanning signal lines and the holding capacitances of the first pixel and the second pixel are formed in the region where the pixel electrode and the holding capacitance line overlap each other in a plan view, it is possible to change the overlapped region.

### BRIEF DESCRIPTION OF THE DRAWINGS

FIG. 1 is a schematic plan view of a liquid crystal display panel as viewed from a viewer's side;

FIG. 2 is a schematic cross-sectional view taken along a line A-A′ in FIG. 1;

FIG. 3 is an enlarged schematic plan view of a region AR1 shown in FIG. 1;

FIG. 4 is a schematic cross-sectional view taken along a line C-C′ in FIG. 3;

FIG. 5 is a schematic cross-sectional view taken along a line D-D′ in FIG. 3;

FIG. 6A and FIG. 6B are schematic plan views for explaining an effect of the liquid crystal display panel of an embodiment 1;

FIG. 7A and FIG. 7B are schematic plan views for explaining an effect of the liquid crystal display panel of the embodiment 1;

FIG. 8 is a schematic cross-sectional view for explaining a first modification of the liquid crystal display panel of the embodiment 1;

FIG. 9 is a schematic cross-sectional view for explaining a second modification of the liquid crystal display panel of the embodiment 1;

FIG. 10 is a schematic plan view showing the schematic constitution of a liquid crystal display panel of an embodiment 2 according to the present invention;

FIG. 11A and FIG. 11B are schematic plan views for explaining an effect of the liquid crystal display panel of the embodiment 2;

FIG. 12A and FIG. 12B are schematic plan views for explaining an effect of the liquid crystal display panel of the embodiment 2;

FIG. 13 is a schematic view for explaining an example of the first driving method of the liquid crystal display panel of the present invention;

FIG. 14 is a schematic view for explaining an example of the second driving method of the liquid crystal display panel of the present invention;

FIG. 15 is a schematic view showing the circuit constitution of one pixel of the liquid crystal display panel of the present invention;

FIG. 16 is a schematic view for explaining a method for obtaining a pixel capacitance of a first pixel in the liquid crystal display panel of the present invention;

FIG. 17 is a schematic view for explaining a method for obtaining a pixel capacitance of a second pixel in the liquid crystal display panel of the present invention;

FIG. 18 is a schematic plan view for explaining a first modification of the liquid crystal display panel of the present invention;

FIG. 19 is a schematic plan view for explaining a second modification of the liquid crystal display panel of the present invention;

FIG. 20 is a schematic plan view showing the constitutions of pixels arranged around a corner portion of a display region within the conventional transflective color liquid crystal display panel; and

FIG. 21 is a schematic cross-sectional view taken along a line F-F′ in FIG. 20.

### DESCRIPTION OF THE PREFERRED EMBODIMENTS

Hereinafter, embodiments of the present invention are explained in detail in conjunction with drawings. Here, in all drawings for explaining the embodiments, parts having identical functions are given same numerals and their repeated explanation is omitted.

### Embodiment 1

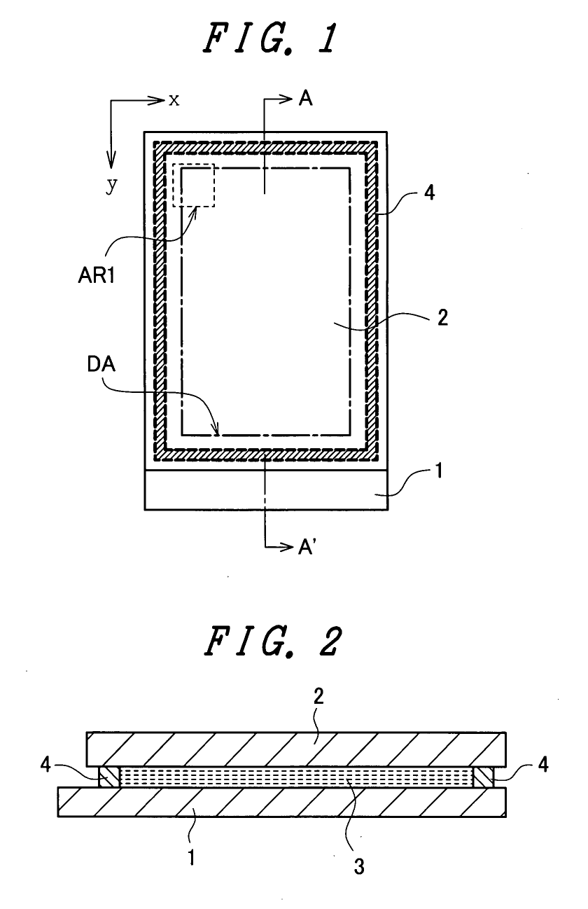

FIG. 1 to FIG. 5 are schematic views showing the schematic constitution of a liquid crystal display panel of an embodiment 1 according to the present invention.

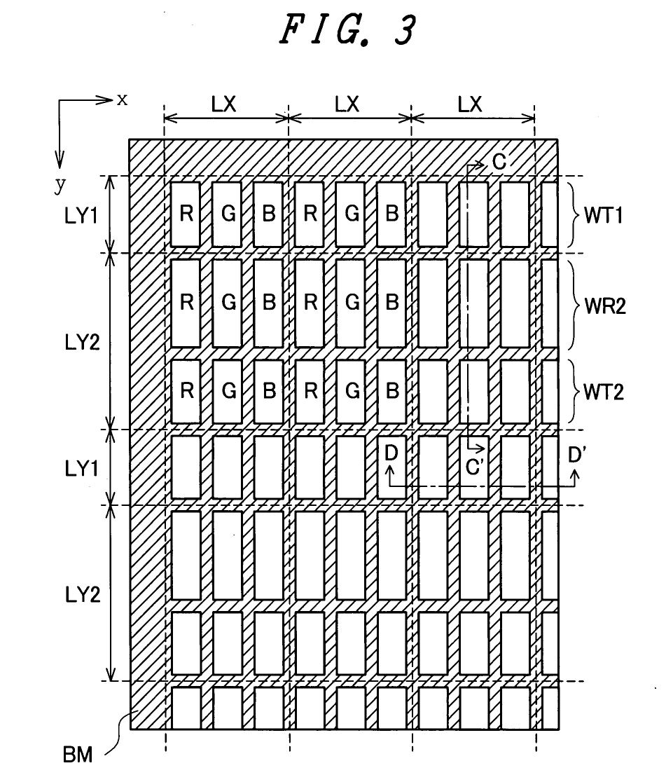

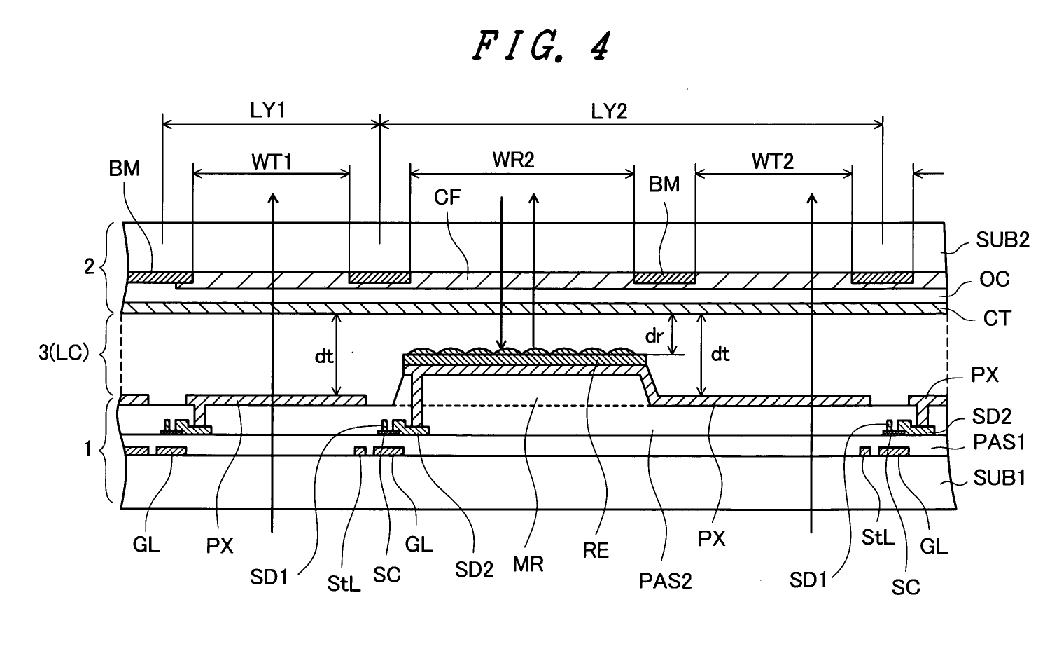

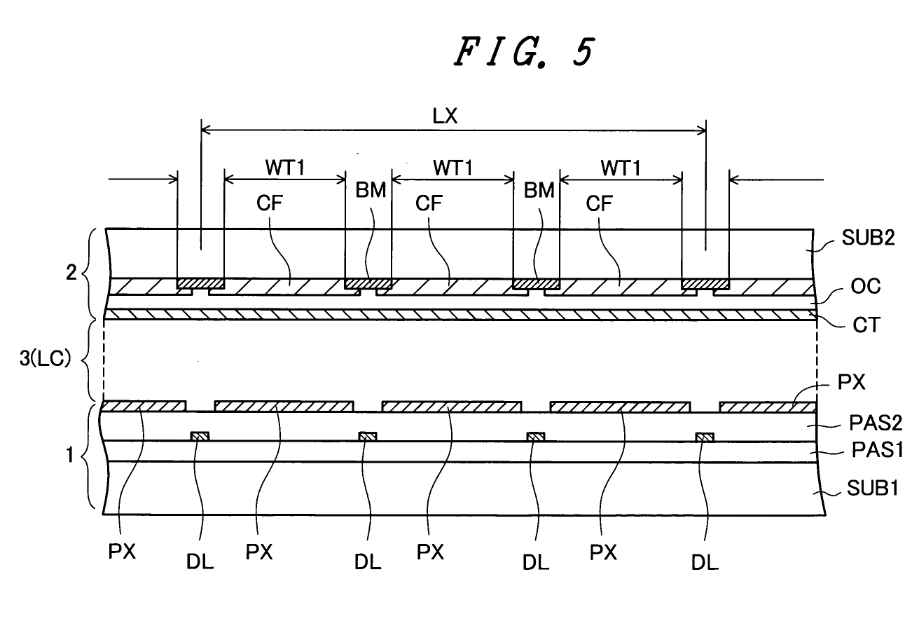

FIG. 1 is a schematic plan view of the liquid crystal display panel as viewed from a viewer's side. FIG. 2 is a schematic cross-sectional view taken along a line A-A′ in FIG. 1. FIG. 3 is an enlarged schematic plan view of a region AR1 shown in FIG. 1. FIG. 4 is a schematic cross-sectional view taken along a line C-C′ in FIG. 3. FIG. 5 is a schematic cross-sectional view taken along a line D-D′ in FIG. 3.

In a liquid crystal display panel of this embodiment 1 is, as shown in FIG. 1 and FIG. 2, a liquid crystal material 3 is sealed between a pair of a TFT substrate 1 and a counter substrate 2. Here, the TFT substrate land the counter substrate 2 are, for example, adhered to each other by a sealing material 4 which is annularly provided outside a display region DA, and the liquid crystal material 3 is sealed into the inside of a space surrounded by the TFT substrate 1, the counter substrate 2 and the sealing material 4.

Further, when the liquid crystal display panel shown in FIG. 1 adopts an RGB-method color liquid crystal display panel, to enlarge a region AR1 around a corner portion on a left and upper side of the display region DA, for example, the region AR1 is constituted as shown in FIG. 3. Here, the x direction and the y direction shown in FIG. 3 agree with the x direction and the y direction shown in FIG. 1.

Further, in FIG. 3, a plurality of broken lines which is drawn in the x direction is lines for dividing a plurality of pixels which is arranged in the y direction for every pixel, and a plurality of broken lines which is drawn in the y direction is lines for dividing a plurality of pixels which is arranged in the x direction for every pixel. That is, in the liquid crystal display panel of the embodiment 1, a region shown in FIG. 3 which is surrounded by two neighboring broken lines drawn in the x direction and two neighboring broken lines drawn in the y direction constitutes one pixel (one dot) of a displayed video or image.

Further, in case of the liquid crystal display panel of the embodiment 1, in the display region DA, a first pixel row in which a plurality of pixels (hereinafter, referred to as first pixels) having a size LX in the x direction and a size LY1 in the y direction is arranged in the x direction and a second pixel row in which a plurality of pixels (hereinafter, referred to as second pixels) having a size LX in the x direction and a size LY2 in the y direction is arranged in the x direction are alternately arranged in the y direction.

Here, the first pixel is a pixel which includes only a transmissive display region WT1 which allows light incident on the liquid crystal display panel from a back side of the liquid crystal display panel as viewed from a viewer side to pass therethrough and radiates the light toward a viewer side. In case of the RGB-method color liquid crystal display panel, three transmissive display regions WT1 formed of the red (R) transmissive display region, the green (G) transmissive display region and the blue (B) transmissive display region are arranged in one pixel.

Further, the second pixel is a pixel which includes a reflective display region WR2 which allows light incident on the liquid crystal display panel from a front side of the liquid crystal display panel as viewed from a viewer side to be reflected thereon and radiates the light toward the viewer side and a transmissive display region WT2. In case of the RGB-method color liquid crystal display panel, three reflective display regions WR2 formed of the red (R) reflective display region, the green (G) reflective display region and the blue (B) reflective display region and three transmissive display regions WT2 formed of the red (R) transmissive display region, the green (G) transmissive display region and the blue (B) transmissive display region are arranged in one pixel.

Further, in the liquid crystal display panel of the embodiment 1, on a boundary portion between two neighboring pixels or a boundary portion between two neighboring display regions, a black matrix BM which prevents light from being leaked from the respective boundary portions is formed, for example.

Next, constitutional examples of the TFT substrate 1 and the counter substrate 2 of the liquid crystal display panel shown in FIG. 3 are briefly explained.

In the liquid crystal display panel shown in FIG. 3, the first pixel is constituted in the same manner as a pixel of the transmissive color liquid crystal display panel which is used in general conventionally. That is, the first pixel is constituted of three sub pixels consisting of a sub pixel which controls a gray scale of the red (R) transmissive display region, a sub pixel which controls a gray scale of the green (G) transmissive display region and a sub pixel which controls a gray scale of the blue (B) transmissive display region.

Further, the second pixel is constituted in the same manner as a pixel of the transflective color liquid crystal display panel which is used in general conventionally. That is, the second pixel is constituted of three sub pixels consisting of a sub pixel which controls gray scales of red (R) reflective display region and transmissive display region, a sub pixel which controls gray scales of green (G) reflective display region and transmissive display region, and a sub pixel which controls gray scales of blue (B) reflective display region and transmissive display region.

Here, on the TFT substrate 1, scanning signal lines which extend in the x direction are arranged at the same positions as the broken lines drawn in the x direction shown in FIG. 3, for example. Further, on the TFT substrate 1, video signal lines which extend in the y direction are arranged at the same positions as the broken lines drawn in the y direction shown in FIG. 3 and at positions where the black matrix BM which divides three sub pixels in one pixel arranged in the x direction is arranged. Further, the region which is surrounded by two neighboring scanning signal lines and two neighboring video signal lines corresponds to one sub pixel region, and a TFT element, a pixel electrode and the like are arranged in each sub pixel.

The cross-sectional constitution taken along a line C-C′ in FIG. 3 of the liquid crystal display panel of the embodiment 1 may be constituted as shown in FIG. 4, for example. Further, the cross-sectional constitution of the liquid crystal display panel of the embodiment 1 taken along a line D-D′ in FIG. 3 is constituted as shown in FIG. 5, for example.

First of all, for example, the TFT substrate 1 mounts scanning signal lines GL and holding capacitance lines StL on a surface of the glass substrate SUB1 which faces the counter substrate 2 in an opposed manner. The scanning signal lines GL and holding capacitance lines StL are arranged in regions where the scanning signal lines GL and holding capacitance lines StL overlap the black matrix which divides the pixels arranged in the y direction as viewed in a plan view and extend in the x direction in FIG. 3.

Further, on the scanning signal lines GL and the holding capacitance lines StL, semiconductor layers SC, drain electrodes SD1 and source electrodes SD2 are mounted by way of a first insulation layer PAS1. Here, the semiconductor layer SC is, for example, made of amorphous silicon (a-Si), and is arranged at a position where the semiconductor layer SC and the scanning signal line GL overlap each other as viewed in a plan view. Further, the TFT element is formed of the scanning signal line GL, the semiconductor layer SC, the first insulation layer PAS1 (gate insulation film) which is interposed between the scanning signal line GL and the semiconductor layer SC, the drain electrode SD1 and the source electrodes SD2.

In this case, on the first insulation layer PAS1, in addition to the semiconductor layers SC, the drain electrodes SD1 and the source electrodes SD2, as shown in FIG. 5, video signal lines DL are mounted. The video signal lines DL are arranged in regions where the video signal lines DL overlap the black matrix which divides the sub pixels arranged in the x direction as viewed in a plan view and extend in the y direction in FIG. 3. Further, the drain electrodes SD1 of the TFT elements are connected to the video signal lines DL.

Further, on the video signal lines DL, the semiconductor layers SC, the drain electrodes SD1 and the source electrodes SD2, pixel electrodes PX are mounted by way of the second insulation layer PAS2. The pixel electrodes PX are connected to the source electrodes SD2 via through holes. In this case, in the reflective display region WR2 of the second pixel, for example, as shown in FIG. 4, a step forming layer MR which projects toward a counter-substrate-2 side is formed, and the pixel electrode PX of the second pixel is mounted on the step forming layer MR in the reflective display region WR2. Further, in the reflective display region WR2 of the second pixel, a reflective electrode RE is mounted on the pixel electrode PX. Further, although not shown in the drawing, an orientation film is mounted on the pixel electrodes PX and the reflective electrode RE.

On the other hand, for example, on a surface of the glass substrate SUB2 which faces the TFT substrate 1, a black matrix BM is mounted. The black matrix BM is, for example, provided for interrupting light leaked from boundaries of neighboring pixels and neighboring sub pixels. The black matrix BM is formed by patterning so as to cover regions where the scanning signal lines GL and the holding capacitance lines StL are formed, regions where the video signal lines DL are formed, and stepped portions of boundaries formed between the reflective display regions WR2 and the transmissive display regions WT2 of the second pixels. Further, on the black matrix BM, color filters CF are mounted. Color filters CF are provided by forming an R (red) color filter resist, a G (green) color filter resist and a B (blue) color filter resist for respective sub pixels.

Further, on the color filters CF, for example, a counter electrode CT is mounted by way of an overcoat layer OC. Further, although not shown in the drawing, an orientation film is mounted on the counter electrode CT.

In the liquid crystal display panel of the embodiment 1 having such a constitution, by mounting the flat counter electrode CT on the counter substrate 2 and by mounting the step forming layers MR on the reflective display regions WR2 of the TFT substrate 1, a distance dt between the pixel electrode PX and the counter electrode CT in the transmissive display regions WT1, WT2 of the first and second pixels and a distance dr between the reflective electrode RE and the counter electrodes CT in the reflective display region WR2 of the second pixel are made different from each other.

In a liquid crystal display device having the liquid crystal display panel of the embodiment 1, for example, as shown in FIG. 4, the transmissive display regions WT1, WT2 of the first pixel and second pixels allows light incident on the liquid crystal display panel from a lower side of the TFT substrate 1 (for example, light from a backlight not shown in the drawing) to pass through the liquid crystal display panel and to be radiated to an upper side (viewer side) of the counter substrate 2. Further, the reflective display region WR2 of the second pixel allows light incident on the liquid crystal display panel from above the counter substrate 2 (for example, sunlight or an illumination light from the outside of the liquid crystal display device) to be reflected using a reflective electrode RE of the TFT substrate 1 and to be radiated to the upper side (viewer side) of the counter substrate 2. Accordingly, by adjusting a thickness of the step forming layer MR of the TFT substrate 1 and thicknesses of the liquid crystal layer LC (liquid crystal material 3) in the transmissive display regions WT1, WT2 so as to set a ratio of the thickness of the liquid crystal layer LC in the transmissive display region and the thickness of the liquid crystal layer LC in the reflective display region to substantially 2:1, it is possible to make an optical path length of light which passes through the liquid crystal layer LC in the transmissive display regions WT1, WT2 and an optical path length of light which passes through the liquid crystal layer LC in the reflective display region WR2 substantially agree with each other. By making the above-mentioned optical path lengths substantially agree with each other, it is possible to allow the grayscale-brightness characteristics in the reflective display region WR of the second pixel and the grayscale-brightness characteristic in the transmissive display region WT2 to become similar to each other. For example, it is possible to set both the brightness in the reflective display region WR2 and the brightness in the transmissive display region WT2 at a maximum grayscale to values which approximate maximum values.

Further, although the illustration and the detailed explanation are omitted, on a back surface of the glass substrate SUB1 of the TFT substrate 1 opposite to a surface thereof which faces the counter substrate 2 and on a back surface of the glass substrate SUB2 of the counter substrate 2 opposite to a surface thereof which faces the TFT substrate 1, polarizers and phase different plates are respectively mounted.

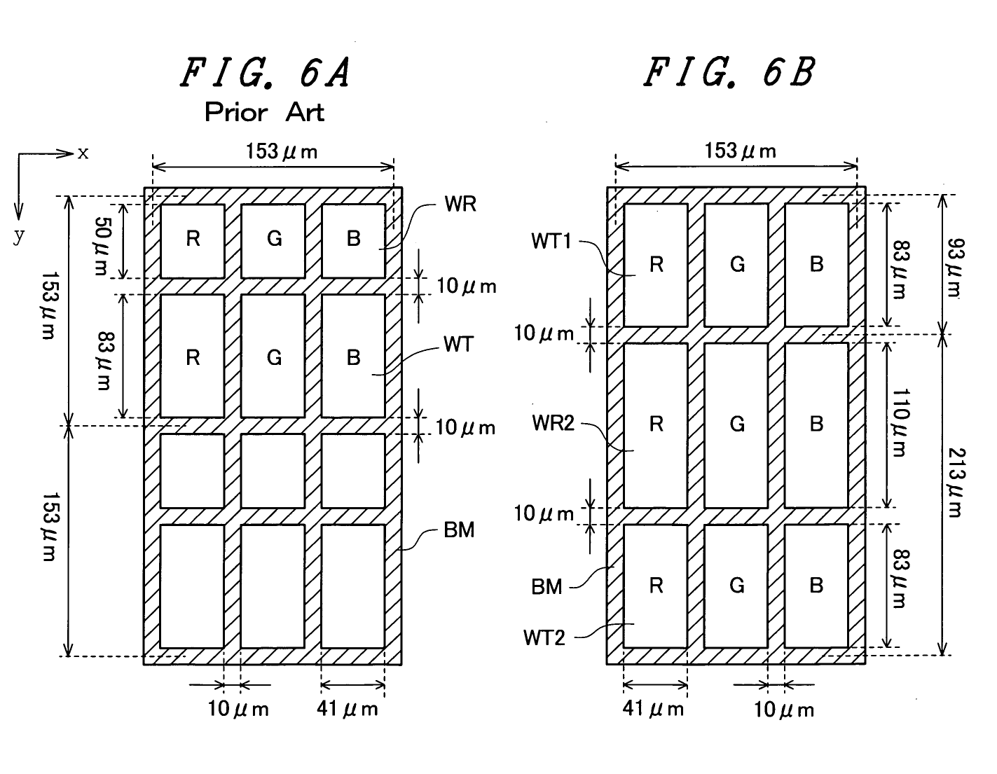

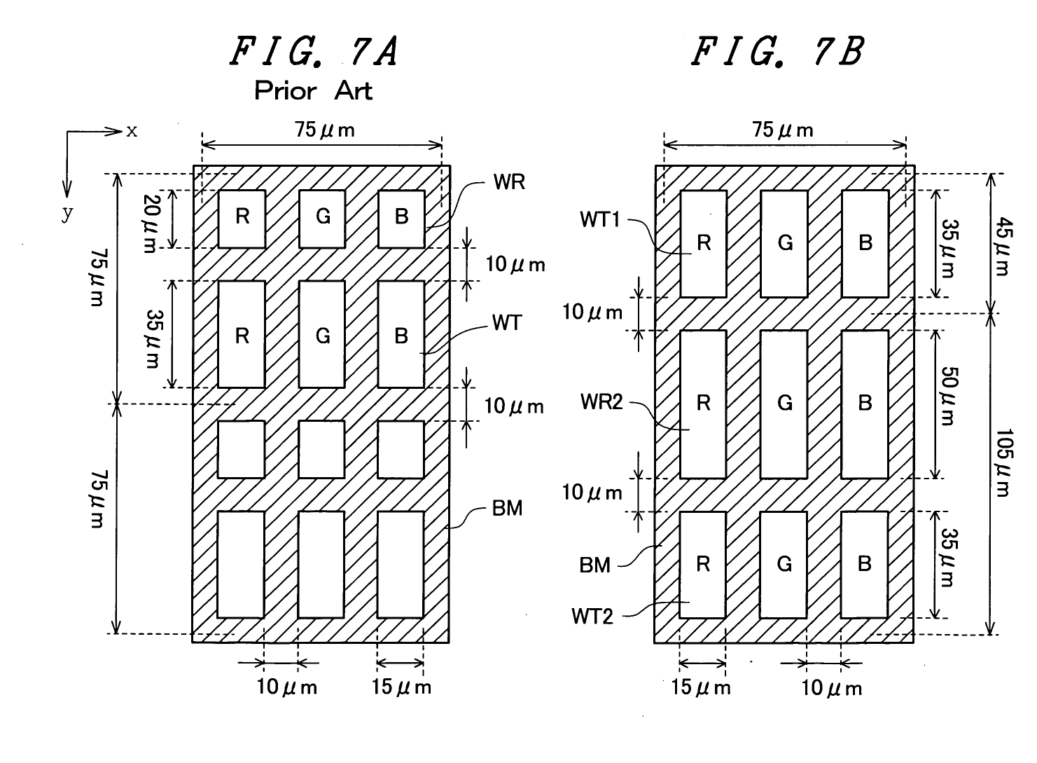

FIG. 6A to FIG. 6B and FIG. 7A and FIG. 7B are schematic plan views for respectively explaining advantageous effects of the liquid crystal display panel of the embodiment 1. Here, FIG. 6A is a plan view showing one constitutional example of pixels of a conventional liquid crystal display panel, and FIG. 6B is a plan view showing one constitutional example of the pixels of the liquid crystal display panel of the embodiment 1. Further, FIG. 7A is a plan view showing another constitutional example of pixels of the conventional liquid crystal display panel, and FIG. 7B is a plan view showing another constitutional example of the pixels of the liquid crystal display panel of the embodiment 1.

In the liquid crystal display panel of the embodiment 1, a first pixel row in which the plurality of first pixels having only the transmissive display region WT1 are arranged in the x direction and a second pixel row in which a plurality of second pixels having the reflective display region WR2 and the transmissive display region WT2 are arranged in the x direction are alternately arranged in the y direction. Accordingly, to explain the advantageous effects of the liquid crystal display panel of the embodiment 1, by focusing on two pixels arranged in the y direction, the relationship among sizes, transmissivities and reflectances of two pixels is explained.

First of all, as a conventional liquid crystal display panel, for example, a transflective color liquid crystal display panel which is used as a display of a mobile phone or the like is named, and one example of sizes, transmissivities and reflectances of two pixels which are arranged in the y direction is explained. In the conventional transflective color liquid crystal display panel, for example, when a diagonal size of a display region is set to 2.4 inches and a display mode (resolution) is QVGA, 320×240 (pieces) pixels exist in the display region. Here, one pixel is, for example, as shown in FIG. 6A, formed in a square shape in which both sizes in the x direction and in the y direction are set to 153 μm respectively. Further, assuming that a width of the black matrix BM which divides sub pixels arranged in the x direction, a width of the black matrix BM which divides two pixels arranged in the y direction and a width of the black matrix BM which divides the reflective display region WR and the transmissive display region WT of the sub pixel of one color are respectively set to 10 μm, and sizes of the reflective display regions WR and the transmissive display regions WT of respective colors in the x direction are set equal to each other, the reflective display regions WR of the respective colors have a size of 41 μm in the x direction and have a size of 50 μm in the y direction respectively. Further, the transmissive display regions WT of the respective colors have a size of 41 μm in the x direction and have a size of 83 μm in the y direction respectively.

In the conventional transflective color liquid crystal display panel as shown in FIG. 6A, a numerical aperture of the reflective display region WR of one pixel, that is, a rate of the reflective display region WR with respect to one pixel region is approximately 26.3%. Further, a numerical aperture of the transmissive display region WT of one pixel, that is, a rate of the transmissive display region WT with respect to one pixel region is approximately 43.6%. Further, in case of the conventional transflective color liquid crystal display panel, in general, sizes of the reflective display regions WR and the transmissive display regions WT of all pixels are equal to each other and hence, also by focusing on two pixels arranged in the y direction, a numerical aperture of the reflective display region WR is approximately 26.3%, and a numerical aperture of the transmissive display region WT is approximately 43.6%.

On the other hand, in the liquid crystal display panel of the embodiment 1, considered is a case in which, for example, a size of first pixel and a size of the second pixel are set such that the sizes of two pixels arranged in the y direction agree with the sizes of two pixels arranged in the y direction shown in FIG. 6A. Here, the first pixel and the second pixel arranged in the y direction assume sizes as shown in FIG. 6B, wherein a size of each pixel in the x direction is 153 μm and a width of the black matrix BM is 10 μm. By allowing numerical apertures of transmissive display regions WT1, WT2 in two pixels arranged in the y direction to agree with a numerical aperture of transmissive display region WT in two pixels arranged in the y direction in FIG. 6A, the transmissive display region WT1 of each color of the first pixel and a size of the transmissive display region WT2 of each color of the second pixel in the x direction may be set to 41 μm and a size thereof in the y direction may be set to 83 μm respectively, for example. Due to such size setting, the size of the first pixel in the y direction becomes 93 μm, the size of the second pixel in the y direction becomes 213 μm, and the size of the reflective display region WR2 of the second pixel in the y direction becomes 110 μm.

In the liquid crystal display panel of the embodiment 1 as shown in FIG. 6B, by focusing on two pixels arranged in the y direction, the numerical aperture of the transmissive display regions WT1, WT2 is approximately 43.6% and hence, the numerical aperture is equal to the numerical aperture of the transmissive display regions WT1, WT2 of the conventional constitution shown in FIG. 6A. On the other hand, the numerical aperture of the reflective display region WR2 becomes approximately 28.9% and hence, the numerical aperture of the reflective display region WR2 is increased by approximately 10% compared to the numerical aperture of the reflective display region WR of the constitution shown in FIG. 6A. Further, in the liquid crystal display panel of the embodiment 1, since sets of the first pixel and the second pixel which are shown in FIG. 6B are arranged over that whole area of the display region DA, it may be possible to estimate that the numerical aperture of the reflective display region with respect to the whole display region is increased by approximately 10% compared to the numerical aperture of the reflective display region of the conventional constitution.

Next, as the conventional liquid crystal display panel, for example, a transflective color liquid crystal display panel which has a diagonal size of a display region is set to 2.4 inches and a display mode (resolution) is VGA is exemplified, and one example of sizes, transmissivities and reflectances of two pixels which are arranged in the y direction is shown. When the resolution is VGA, for example, 640×480 (pieces) pixels exist in the display region. Accordingly, when a diagonal size of the display region is set equal to the diagonal size of the display region in the above-mentioned QVGA transflective color liquid crystal display panel, a size of one pixel becomes smaller than a size of one pixel in the above-mentioned QVGA transflective color liquid crystal display panel. Here, one pixel is, for example, as shown in FIG. 7A, formed in a square which sets both sizes in the x direction as well as in the y direction to 75 μm. However, a width of the black matrix BM which divides sub pixels arranged in the x direction, a width of the black matrix BM which divides two pixels arranged in the y direction and a width of the black matrix BM which divides the reflective display region WR and the transmissive display region WT of the sub pixel of one color are respectively determined by widths of the scanning signal line GL and the holding capacitance line StL, and a width of the image signal line LD or the like which are mounted on the TFT substrate 1 and hence, the widths of the black matrixes become 10 μm as in the example shown by FIG. 6A. Here, when the sizes of the reflective display region WR and the transmissive display region WT of respective colors in the x direction are set equal to each other, the size of the reflective display region WR of respective colors in the x direction becomes 15 μm and the size of the reflective display region WR of respective colors in the y direction becomes 20 μm. Further, the size of the transmissive display region WT of respective colors in the x direction becomes 15 μm and the size thereof in the y direction becomes 35 μm.

In the conventional transflective color liquid crystal display panel as shown in FIG. 7A, a numerical aperture of the reflective display region WR of one pixel is approximately 16.0%. Further, a numerical aperture of the transmissive display region WT of one pixel is approximately 28.0%. Further, in case of the conventional transflective color liquid crystal display panel, in general, sizes of the reflective display regions WR and the transmissive display regions WT of all pixels are equal to each other and hence, also by focusing on two pixels arranged in they direction, a numerical aperture of the reflective display region WR is approximately 16.0%, and a numerical aperture of the transmissive display region WT is approximately 28.0%.

On the other hand, in the liquid crystal display panel of the embodiment 1, considered is a case in which, for example, a size of first pixel and a size of the second pixel are set such that the sizes of two pixels arranged in the y direction agree with the sizes of two pixels arranged in the y direction shown in FIG. 7A. Here, the first pixel and the second pixel arranged in the y direction assume sizes as shown in FIG. 7B, wherein a size of each pixel in the x direction is 75 μm and a width of the black matrix BM is 10 μm. Here, by allowing a numerical aperture of transmissive display regions WT1, WT2 in two pixels arranged in the y direction to agree with a numerical aperture of transmissive display region WT in two pixels arranged in the y direction in FIG. 7A, the transmissive display region WT1 of each color of the first pixel and the transmissive display region WT2 of each color of the second pixel may have a size in the x direction of 15 μm and a size in the y direction of 35 μm respectively, for example. Due to such size setting, the size of the first pixel in the y direction becomes 45 μm, the size of the second pixel in the y direction becomes 105 μm, and the size of the reflective display region WR2 of the second pixel in the y direction becomes 50 μm.

In the liquid crystal display panel of the embodiment 1 as shown in FIG. 7B, by focusing on two pixels arranged in the y direction, the numerical aperture of the transmissive display regions WT1, WT2 is approximately 28.0% and hence, the numerical aperture is equal to the numerical aperture of the transmissive display regions WT1, WT2 of the conventional constitution shown in FIG. 7A. On the other hand, the numerical aperture of the reflective display region WR2 becomes approximately 20.0% and hence, the numerical aperture of the reflective display region WR2 is increased by approximately 25% compared to the numerical aperture of the reflective display region WR of the conventional constitution shown in FIG. 7A. Further, in the liquid crystal display panel of the embodiment 1, since sets of the first pixel and the second pixel which are shown in FIG. 7B are arranged over that whole area of the display region DA and hence, it may be possible to estimate that the numerical aperture of the reflective display region with respect to the whole display region is increased by approximately 25% compared to the numerical aperture of the reflective display region of the conventional constitution.

From the above, the liquid crystal display panel of the embodiment 1 can make the reflective display region thereof exhibit the reflectance higher than the reflectance of the reflective display region of the conventional transflective liquid crystal display panel while maintaining the transmissivity substantially equal to the transmissivity of the transmissive display region of the conventional transflective liquid crystal display panel. Accordingly, for example, the liquid crystal display panel of the embodiment can perform the bright reflective display in the reflective display region compared to the conventional transflective liquid crystal display panel while allowing the transmissive display regions to maintain the transmissive display of the substantially equal brightness as the transmissive display regions of the conventional liquid crystal display panel.

Further, in the liquid crystal display panel of the embodiment 1, an advantageous effect of making the reflective display region thereof exhibit the reflectance higher than the reflectance of the reflective display region of the conventional transflective liquid crystal display panel while maintaining the transmissivity substantially equal to the transmissivity of the transmissive display region of the conventional transflective liquid crystal display panel is increased with decrease of a size of one pixel.

Further, although a detailed explanation is omitted, in the liquid crystal display panel of the embodiment 1, for example, when the numerical aperture of the reflective display region by focusing on two pixels arranged in the y direction is set substantially equal to the numerical aperture of the reflective display region of the conventional transflective liquid crystal display panel, it is possible to make the transmissivity of the transmissive display region higher than the transmissivity of the transmissive display region of the conventional transflective liquid crystal display panel.

Here, in general, the transflective liquid crystal display panel exhibits poor visibility compared to the transmissive display. Accordingly, in the liquid crystal display panel of the embodiment 1, for example, as shown in FIG. 6B or FIG. 7B, it is desirable to set the numerical aperture of the transmissive display region substantially equal to the numerical aperture of the transmissive display region of the conventional transflective liquid crystal display panel and to set the numerical aperture of the reflective display region higher than the numerical aperture of the reflective display region of the conventional transflective liquid crystal display device.

Further, in the liquid crystal display panel of the embodiment 1, it is desirable that an area of the transmissive display region WT1 of the first pixel and an area of the transmissive display region WT2 of the second pixel are substantially equal to each other. Due to such a constitution, a display of a video or an image on performing the transmissive display become uniform. Further, with respect to areas of the respective transmissive display regions at that time, it is preferable that the error thereof fall within a range of ±5% and hence, when the areas have the error which falls within this range, the areas may be assumed as having equal area. Further, in the liquid crystal display panel of the embodiment 1, a size LY2 of the second pixel in the y direction is set larger than a size LY1 of the first pixel in the y direction so that the area of the transmissive display region WT1 of the first pixel and the area of the transmissive display region WT2 of the second pixel become substantially equal.

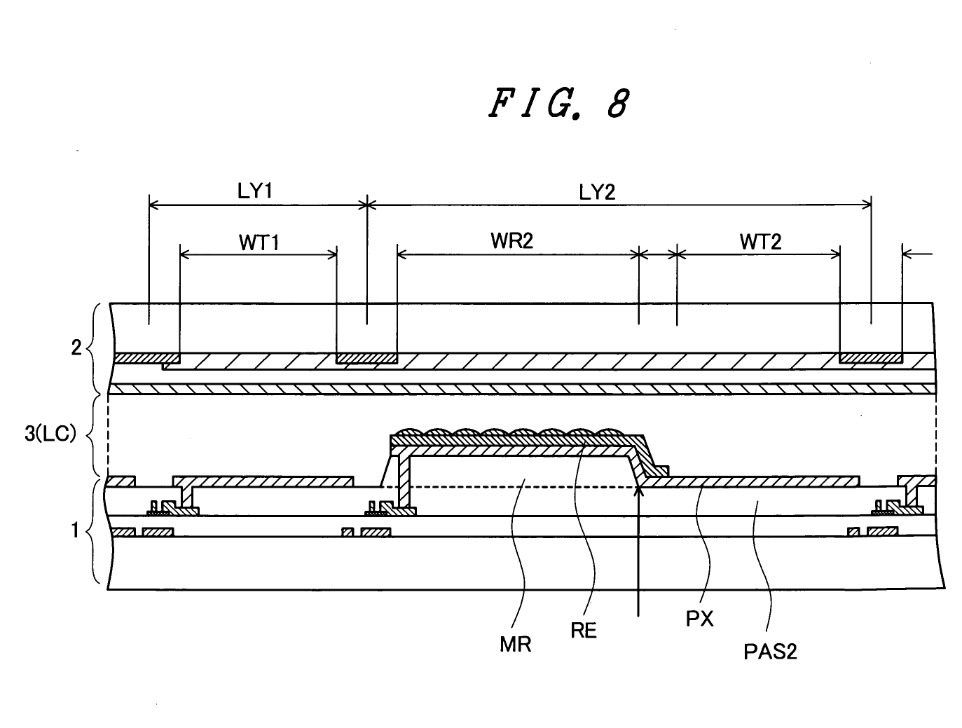

FIG. 8 is a schematic cross-sectional view for explaining a first modification of the liquid crystal display panel of the embodiment 1. Here, FIG. 8 is a cross-sectional view corresponding to a cross-section taken along a line C-C′ in FIG. 3.

In the liquid crystal display panel of the embodiment 1, for example, as shown in FIG. 3 and FIG. 4, the black matrix BM which is overlapped with a step portion which divides the second pixel into the reflective display region WR2 and the transmissive display region WT2 as viewed in a plan view is provided on the counter substrate 2 whereby a light leaked from the step portion is blocked. However, the liquid crystal display panel of the embodiment 1 is not limited to this and, for example, as shown in FIG. 8, the reflective electrode RE which is mounted on the reflective display region WR2 of the second pixel may be allowed to extend to the transmissive display region WT2 side whereby the step portion is covered with the reflective electrode RE. The reflective electrode RE reflects the light incident from the counter substrate 2 side and, at the same time, has a function to block light incident from the TFT substrate 1 side and hence, even when the constitution as shown in FIG. 8 is adopted, it is possible to prevent leakage of light generated at the step portion.

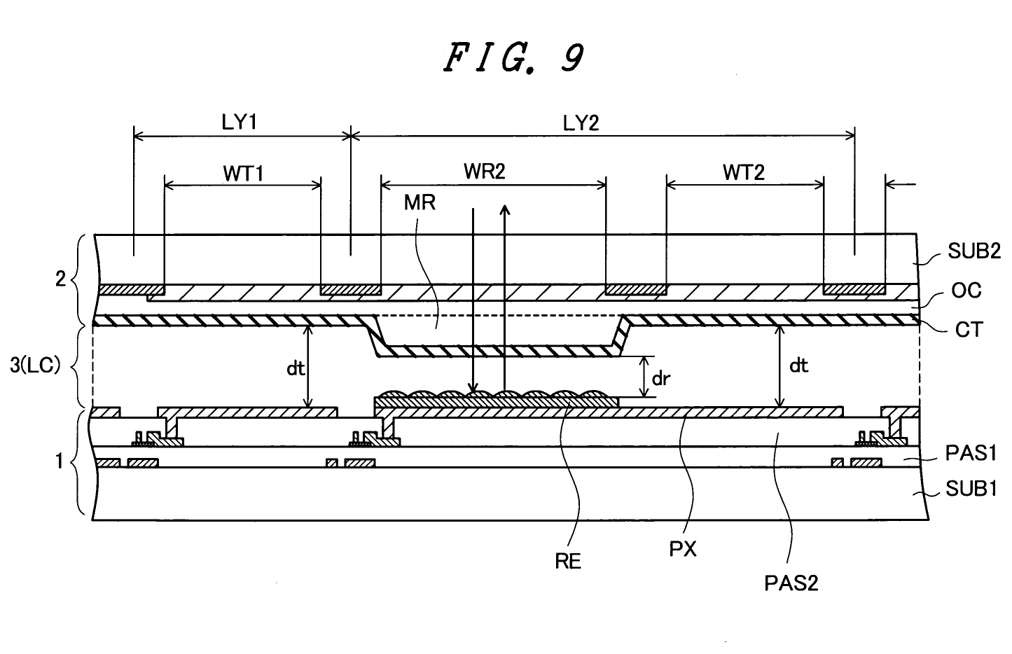

FIG. 9 is a schematic cross-sectional view for explaining a second modification of the liquid crystal display panel of the embodiment 1. Here, FIG. 9 is a cross-sectional view corresponding to a cross-section taken along a line C-C′ in FIG. 3.

In the liquid crystal display panel of the embodiment 1, for example, a step forming layer MR as shown in FIG. 4 is formed in the reflective display region WR2 of the TFT substrate 1 thus differentiating a thickness of a liquid crystal layer LC in the transmissive display regions WT1, WT2 and a thickness of a liquid crystal layer LC of the reflective display region WR2. However, the liquid crystal display panel of the embodiment 1 is not limited to this and, for example, as shown in FIG. 9, the step forming layer MR may be formed in the reflective display region WR2 of the counter substrate 2.

Further, in the embodiment 1, as one example of the constitution of a cross-sectional constitution of the liquid crystal display panel, that is, the constitution of the TFT substrate 1 or the counter substrate 2, the constitution as shown in FIG. 4 and FIG. 5 is named. However, the liquid crystal display panel of the embodiment 1 is not limited to such a constitution and, as the constitution of the second pixel, any of various constitutions applied to the conventional transflective liquid crystal display panel may be adopted.

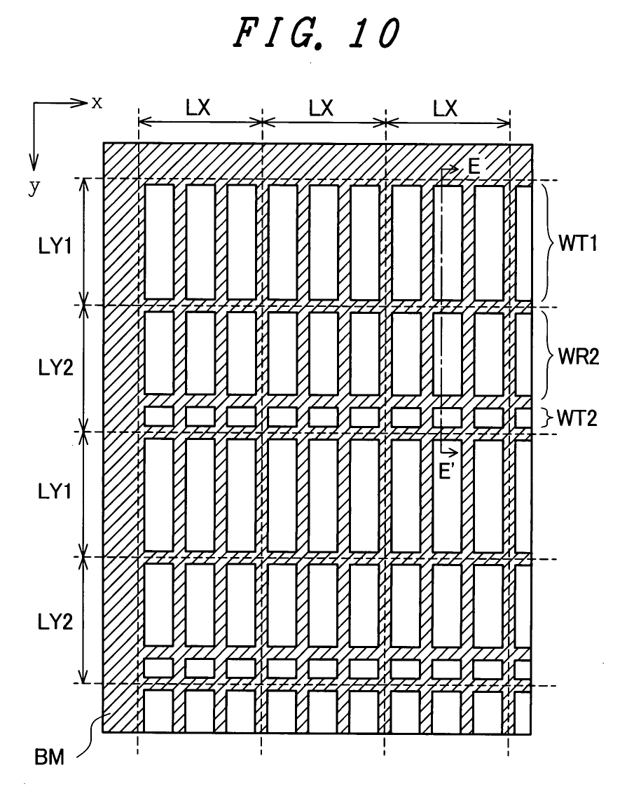

FIG. 10 is a schematic plan view showing the schematic constitution of the liquid crystal display panel of the embodiment 2 according to the present invention. Here, FIG. 10 is a plan view showing a region AR1 in FIG. 1 in an enlarged manner, and the x direction and the y direction shown in FIG. 10 respectively agree with the x direction and the y direction shown in FIG. 1.

The liquid crystal display panel of the embodiment 2 is equal to the liquid crystal display panel of the embodiment 1 with respect to the point that a first pixel row which is formed by arranging a plurality of first pixels which have only transmissive display region WT1 in the x direction and a second pixel row which is formed by arranging pixels which have the reflective display region WR2 and the transmissive display region WT2 in the x direction are alternately arranged in the y direction.

However, in the liquid crystal display panel of the embodiment 2, for example, as shown in FIG. 10, a size LY1 of the first pixel in the y direction and a size LY2 of the second pixel in the y direction are equal to each other. Accordingly, the area of the transmissive display region WT1 of the first pixel differs from the area of the transmissive display region WT2 of the second pixel. Here, for example, the planar constitution of each pixel as viewed from the viewer's side shown in FIG. 10 is substantially equal to the planar constitution shown in FIG. 3 and only differs in the size LY1 of the first pixel in the y direction, the size LY2 of the second pixel in the y direction, a size of the transmissive display region WT1 of the first pixel in the y direction, sizes of the reflective display region WR2 and the transmissive display region WT2 of the second pixel in the y direction. Further, the cross-sectional constitution of the liquid crystal display panel taken along a line E-E′ shown in FIG. 10 is substantially equal to the cross-sectional constitution shown in FIG. 4 and only differs in the size LY1 of the first pixel in the y direction, the size LY2 of the second pixel in the y direction, a size of the transmissive display region WT1 of the first pixel in the y direction, sizes of the reflective display region WR2 and the transmissive display region WT2 of the second pixel in the y direction. Accordingly, the detailed explanation of the planar constitution and the cross-sectional constitution of the liquid crystal display panel of the embodiment 2 is omitted.

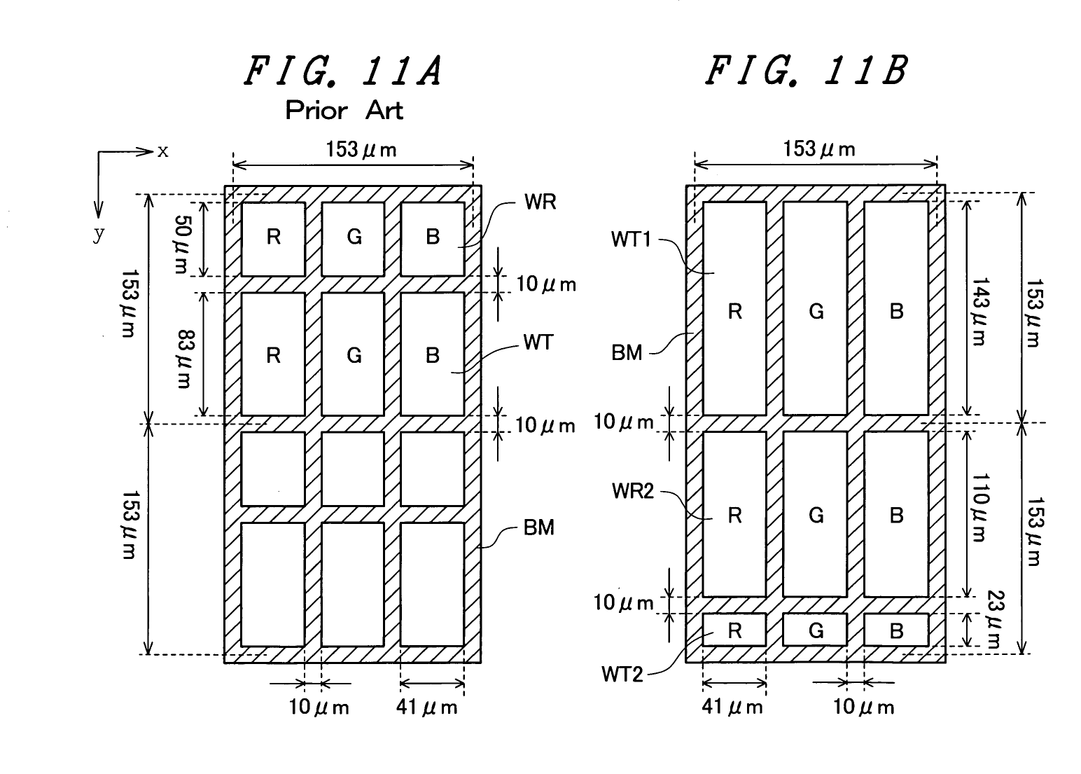

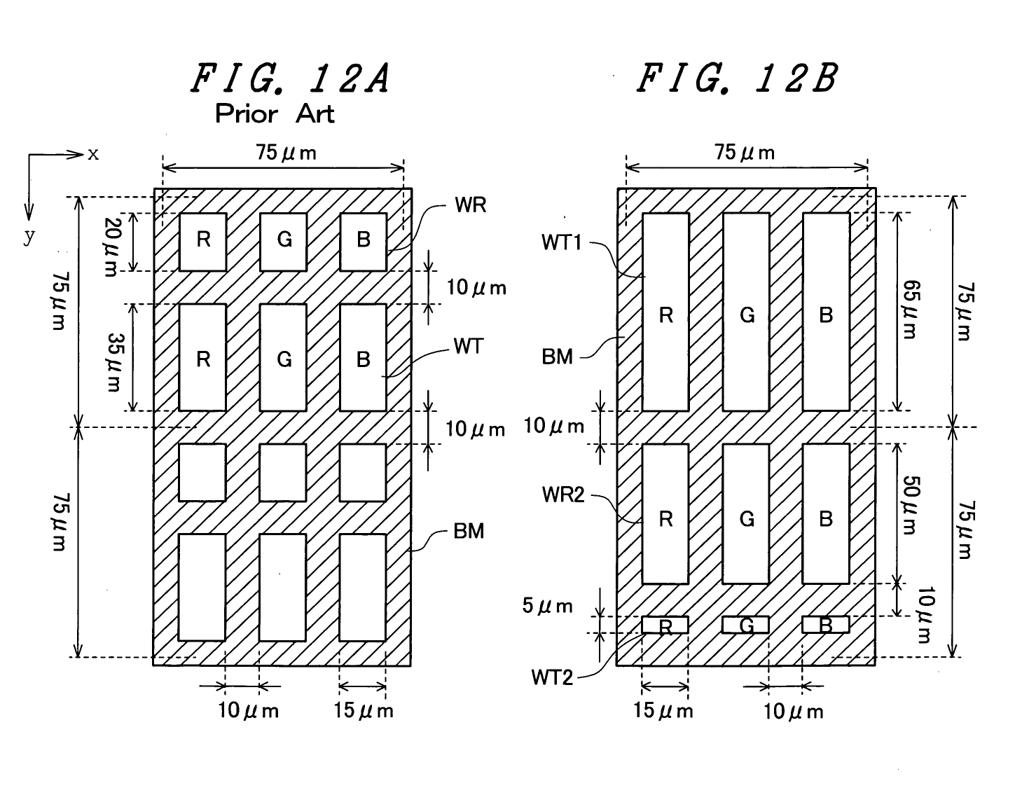

FIG. 11A to FIG. 11B and FIG. 12A and FIG. 12B are schematic plan views for respectively explaining advantageous effects of the liquid crystal display panel of the embodiment 2. Here, FIG. 11A is a plan view showing one constitutional example of pixels of a conventional liquid crystal display panel, and FIG. 11B is a plan view showing one constitutional example of the pixels of the liquid crystal display panel of the embodiment 2. Further, FIG. 12A is a plan view showing another constitutional example of pixels of the conventional liquid crystal display panel, and FIG. 12B is a plan view showing another constitutional example of the pixels of the liquid crystal display panel of the embodiment 2.

In the liquid crystal display panel of the embodiment 2 also, a first pixel row in which the plurality of first pixels having only the transmissive display region WT1 are arranged in the x direction and a second pixel row in which a plurality of second pixels having the reflective display region WR2 and the transmissive display region WT2 are arranged in the x direction are alternately arranged in the y direction. Accordingly, to explain the advantageous effects of the liquid crystal display panel of the embodiment 2 also, by focusing on two pixels arranged in the y direction, a relationship of the size, transmissivity and reflectance between two pixels is explained.

First of all, as the conventional liquid crystal display panel, for example, a transflective color liquid crystal display panel which is used in a display of a mobile phone terminal or the like is named, and one example of size, transmissivity and reflectance of two pixels which are arranged in the y direction is shown. In the conventional transflective color liquid crystal display panel, for example, when a diagonal size of a display region is set to 2.4 inch and a display mode (resolution) is QVGA, 320×240 (pieces) pixels exist in the display region. Here, one pixel is, for example, as shown in FIG. 11A, formed in a square which sets both sizes in the x direction as well as in the y direction to 153 μm. Further, when a width of the black matrix BM which divides sub pixels arranged in the x direction, a width of the black matrix BM which divides two pixels arranged in the y direction and a width of the black matrix BM which divides the reflective display region WR and the transmissive display region WT of the sub pixel of one color are respectively set to 10 μm, and sizes of the reflective display regions WR and the transmissive display regions WT of respective colors in the x direction are set equal to each other, the reflective display regions WR of the respective colors have a size of 41 μm in the x direction and have a size of 50 μm in the y direction respectively. Further, the transmissive display regions WT of the respective colors have a size of 41 μm in the x direction and have a size of 83 μm in the y direction respectively.

In the conventional transflective color liquid crystal display panel as shown in FIG. 11A, a numerical aperture of the reflective display region WR of one pixel, that is, a rate of the reflective display region WR with respect to one pixel region is approximately 26.3%. Further, a numerical aperture of the transmissive display region WT of one pixel, that is, a rate of the transmissive display region WT with respect to one pixel region is approximately 43.6%. Further, in case of the conventional transflective color liquid crystal display panel, in general, sizes of the reflective display regions WR and the transmissive display regions WT of all pixels are equal to each other and hence, also by focusing on two pixels arranged in the y direction, a numerical aperture of the reflective display region WR is approximately 26.3%, and a numerical aperture of the transmissive display region WT is approximately 43.6%.

On the other hand, in the liquid crystal display panel of the embodiment 2, considered is a case in which, for example, a size of first pixel and a size of the second pixel are set such that the sizes of two pixels arranged in the y direction agree with the sizes of two pixels arranged in the y direction shown in FIG. 11A. Here, the first pixel and the second pixel arranged in the y direction assume sizes as shown in FIG. 11B, wherein both sizes of each pixel in the x direction and the in the y direction are respectively 153 μm and a width of the black matrix BM is 10 μm. Here, at that time, since the first pixel is constituted of only transmissive display region WT1 and hence, a size of the transmissive display region WT1 of each color in the x direction becomes 41 μm and a size thereof in the y-direction becomes 143 μm. Still further, by allowing a numerical aperture of transmissive display regions WT1, WT2 by focusing on two pixels arranged in the y direction to agree with a numerical aperture of transmissive display region WT by focusing on two pixels arranged in the y direction in FIG. 11A, a size of the transmissive display region WT2 of each color of the second pixel in the y direction may be set to 23 μm. Due to such size setting, the size of the reflective display region WR2 of the second pixel in the y direction becomes 110 μm.

In the liquid crystal display panel of the embodiment 2 as shown in FIG. 11B, by focusing on two pixels arranged in the y direction, the numerical aperture of the transmissive display regions WT1, WT2 is approximately 43.6% and hence, the numerical aperture is equal to the numerical aperture of the transmissive display regions WT1, WT2 of the conventional constitution shown in FIG. 11A. On the other hand, the numerical aperture of the reflective display region WR2 becomes approximately 28.9% and hence, the numerical aperture of the reflective display region WR2 is increased by approximately 10% compared to the numerical aperture of the reflective display region WR of the constitution shown in FIG. 11A. Further, in the liquid crystal display panel of the embodiment 2, since sets of the first pixel and the second pixel which are shown in FIG. 11B are arranged over that whole area of the display region DA and hence, it may be possible to estimate that the numerical aperture of the reflective display region with respect to the whole display region is increased by approximately 10% compared to the numerical aperture of the reflective display region of the conventional constitution.

Next, as the conventional liquid crystal display panel, for example, a transflective color liquid crystal display panel which has a diagonal size of a display region is set to 2.4 inch and a display mode (resolution) is VGA is exemplified, and one example of size, transmissivity and reflectance of two pixels which are arranged in the y direction is shown. When the resolution is VGA, 640×480 (pieces) pixels exist in the display region. Accordingly, when a diagonal size of the display region is set equal to the diagonal size of the display region in the above-mentioned QVGA transflective color liquid crystal display panel, a size of one pixel becomes smaller than a size of one pixel in the above-mentioned QVGA transflective color liquid crystal display panel. Here, one pixel is, for example, as shown in FIG. 12A, formed in a square which sets both sizes in the x direction as well as in the y direction to 75 μm. However, a width of the black matrix BM which divides sub pixels arranged in the x direction, a width of the black matrix BM which divides two pixels arranged in the y direction and a width of the black matrix BM which divides the reflective display region WR and the transmissive display region WT of the sub pixel of one color are respectively determined by widths of the scanning signal line GL and the holding capacitance line StL, a width of the image signal line DL or the like and hence, the widths of the black matrixes become 10 μm as in the example shown by FIG. 11A. Here, when the sizes of the reflection region WR and the transmissive display region WT of respective colors in the x direction are set equal to each other, the size of the reflective display region WR of respective colors in the x direction becomes 15 μm and the size thereof in the y direction becomes 20 μm. Further, the size of the transmissive display region WT of respective colors in the x direction becomes 15 μm and the size thereof in the y direction becomes 35 μm respectively.

In the conventional transflective color liquid crystal display panel as shown in FIG. 12A, a numerical aperture of the reflective display region WR of one pixel is approximately 16.0%. Further, a numerical aperture of the transmissive display region WT of one pixel is approximately 28.0%. Further, in case of the conventional transflective color liquid crystal display panel, in general, sizes of the reflective display regions WR and the transmissive display regions WT of all pixels are equal to each other and hence, also by focusing on two pixels arranged in the y direction, a numerical aperture of the reflective display region WR is approximately 16.0%, and a numerical aperture of the transmissive display region WT is approximately 28.0%.

On the other hand, here considered is a case in which, in the liquid crystal display panel of the embodiment 2, for example, the sizes of the first pixel and the second pixel are set to agree with the sizes of two pixels which are arranged in the y direction shown in FIG. 12A. Here, with respect to the first pixel and the second pixel in the y direction, as shown in FIG. 12B, the size in the x direction and the size in the y direction of each pixel are respectively 75 μm, and a width of the black matrix BM is 10 μm. Here, the first pixel is constituted of only transmissive display regions WT1 and hence, with respect to the transmissive display regions WT1 of respective colors, the size in the x direction becomes 15 μm and the size in the y direction becomes 65 μm. Still further, to make numerical apertures of the transmissive display regions WT1, WT2 arranged in the y direction agree with the numerical apertures of the transmissive display regions WT by focusing on two pixels arranged in the y direction, shown in FIG. 12A, the sizes in the y direction of the respective transmissive display regions WT2 of each color of the second pixel may be set to 5 μm. By setting the sizes of the transmissive display regions WT in this manner, the size in the y direction of the reflective display regions WR2 of the second pixel is 50 μm.

In the liquid crystal display panel of the embodiment 2 shown in FIG. 12B, to focus on two pixels in the y direction, numerical apertures of the transmissive display regions WT1, WT2 are approximately 28.0% and have the same constitution as the conventional constitution shown in FIG. 12A. On the other hand, the numerical aperture of the reflective display regions WR2 becomes approximately 20.0% and is increased by approximately 25.0% compared to the numerical aperture of the reflective display regions WR of conventional constitution shown in FIG. 12A. Further, in the case of the liquid crystal display panel of the embodiment 2, the sets each of which is formed of the first pixel and the second pixel shown in FIG. 12B are arranged over the whole area of the display region DA and hence, it is estimated that the numerical aperture of the reflective display regions as viewed in the whole display region is increased by approximately 25.0% compared with the numerical aperture of the reflective display regions of the conventional liquid crystal display panel.

As described above, the liquid crystal display panel of the second embodiment can also obtain the same advantageous effects as the liquid crystal display panel of the embodiment 1. For example, while allowing the transmissive display regions to maintain the transmissive display of the substantially equal brightness as the transmissive display regions of the conventional liquid crystal display panel, the liquid crystal display panel of the second embodiment can perform the bright reflective display in the reflective display regions compared to reflective display regions of the conventional liquid crystal display panel.

Further, also in the liquid crystal display panel of the embodiment 2, the smaller the size of one pixel, an advantageous effect can be increased that while maintaining the transmissivity of the transmissive display regions substantially equal to the transmissivity of the transmissive display regions of the conventional transflective liquid crystal display panel, the reflectance of the reflective display region can be increased compared to the reflectance of the reflective display region of the conventional transflective liquid crystal display panel.

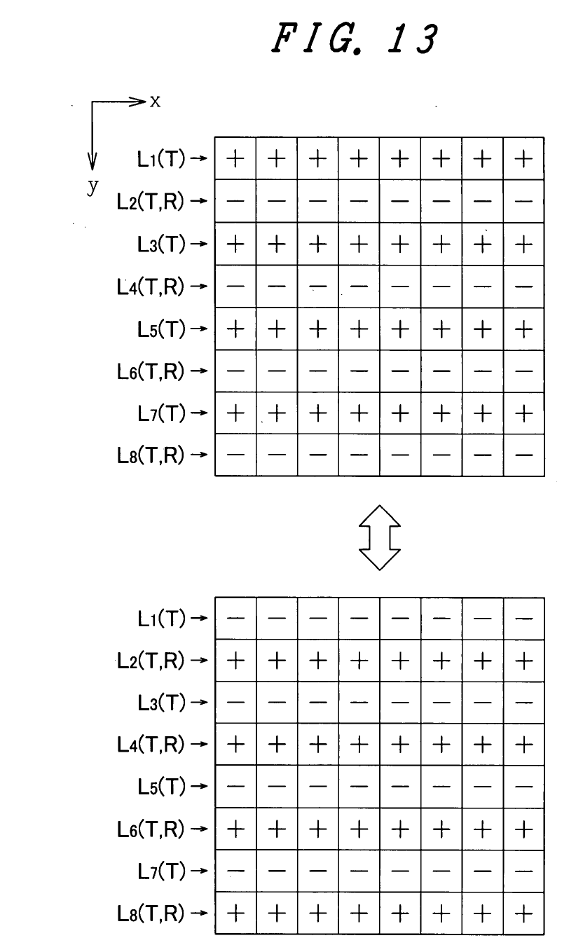

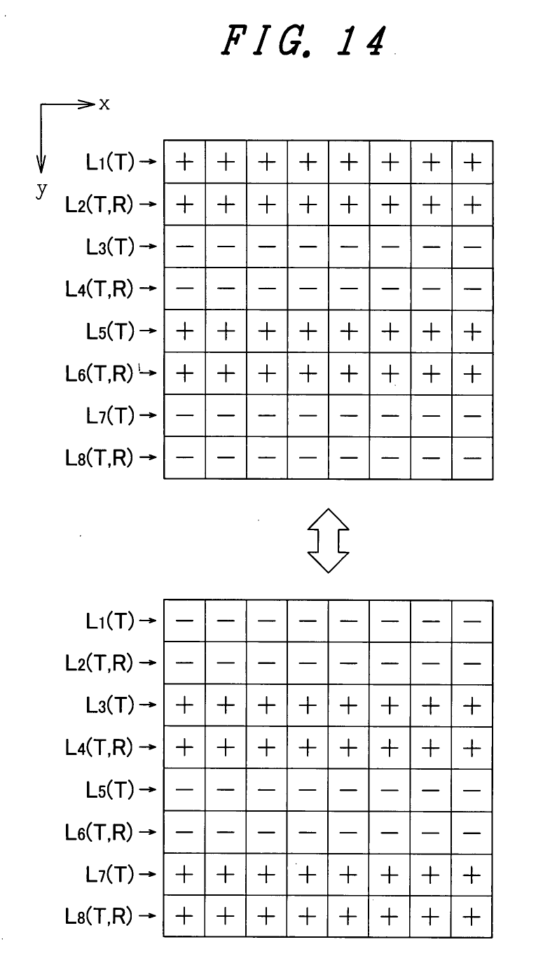

FIG. 13 is a schematic view for explaining one example of a first driving method of the liquid crystal display panel of the present invention. FIG. 14 is a schematic view for explaining one example of a second driving method of the liquid crystal display panel of the present invention.

In the conventional liquid crystal display panel, when a gray scale signal is applied to each pixel electrode of the respective pixel, in general, the polarity of the pixel electrode with respect to a potential of the common electrode is inverted for every preset number of frames. That is, when the polarity is inverted for every frame, to the pixel electrode to which the signal having the potential higher than the potential of the common electrode (referred to as positive polarity) is applied in one frame, the signal having the potential lower than the potential of the common electrode (referred to as negative polarity) is applied in another frame. In a conventional liquid crystal display panel, by inverting the polarities of the pixels in this manner, flickers and image retention can be prevented.

As the driving method which inverts the polarities of the pixel electrodes, for example, there has been known a driving method which is referred to as line inversion driving. FIG. 13 shows the polarities of the respective pixels for performing the line inversion driving of the liquid crystal display panel in the embodiment 1 or the embodiment 2. In FIG. 13, a case in which 64 pixels are formed with 8 pixels arranged in the x direction and 8 pixels arranged in the y direction is exemplified. In FIG. 13, each square corresponds to the pixel, wherein the squares indicated by “+” are pixels to which a signal of positive polarity is applied, and the squares indicated by “−” are pixels to which a signal of negative polarity is applied. Further, in FIG. 13, L₁ (T), L₃ (T), L₅ (T), L₇ (T) are first pixel rows in which only the first pixels each having only the transmissive display region WT1 are arranged, while L₂ (T, R), L₄ (T, R), L₆ (T, R), L₈ (T, R) are second pixel rows in which the second pixels each having the reflective display region WR2 and the transmissive display region WT2 are arranged.

In performing the line inversion driving of the liquid crystal display panel in the embodiment 1 or the embodiment 2, for example, when a video or an image during a certain frame period is displayed, as shown in an upper side of FIG. 13, a signal of positive polarity is applied to the pixel electrodes PX of the pixels of the respective pixel rows of L₁ (T), L₃ (T), L₅ (T), L₇ (T), and a signal of negative polarity is applied to the pixel electrodes PX of the pixels of the respective pixel rows of L₂ (T, R), L₄ (T, R), L₆ (T, R), L₈ (T, R).

Then, for example, when a video or an image of a next frame period is displayed, the polarity is inverted. That is, a signal of negative polarity is applied to the pixels to which the signal of positive polarity is applied in the previous frame, and a signal of positive polarity is applied to the pixels to which the signal of negative polarity is applied in the previous frame. That is, as shown in a lower side of FIG. 13, the signal of negative polarity is applied to the pixel electrodes PX of the pixels of the respective pixel rows of L₁ (T), L₃ (T), L₅ (T), L₇ (T), and the signal of positive polarity is applied to the pixel electrodes PX of the pixels of the respective pixel rows of L₂ (T,R), L₄ (T,R), L₆ (T,R), L₈ (T,R).

In the conventional liquid crystal display panel, since the constitutions of the pixels of each pixel row are equal, by changing over a pattern shown in an upper side of FIG. 13 and a pattern shown in a lower side of FIG. 13 for every preset number of frames, it is possible to prevent flickers and image retention.

However, in case of the liquid crystal display panel of the embodiment 1 or the embodiment 2, the first pixel rows in which only the first pixels each having only the transmissive display region WT1 are arranged in the x direction and second pixel rows in which the second pixels each having the reflective display region WR2 and the transmissive display region WT2 are arranged in the x direction are alternately arranged in the y direction. Accordingly, when the line inversion driving is applied to the liquid crystal display panel, the signal of the same polarity is applied to the pixel electrodes PX of the respective first pixel rows. To explain this line inversion driving in conjunction with the example shown in FIG. 13, the first pixel rows are L₁ (T), L₃ (T), L₅ (T), L₇ (T), and when the signal of positive polarity is applied to the respective pixels of L₁ (T), the signal of positive polarity is also applied to the pixels of the remaining respective first pixel rows. In the same manner, the signal of same polarity (negative polarity) is also applied to the pixels of the respective remaining second pixel rows.

In this manner, when the line inversion driving of the liquid crystal display panel of the embodiment 1 or the embodiment 2 is performed, to focus on the display during one frame, the polarities of the first pixels and the second pixels are biased. Although the biasing of the polarities causes no problem so long as a transmissive display is mainly performed, there arises a following drawback when a reflective display is mainly performed.

For example, in a place under sunlight, the reflective display regions WR2 of the second pixels mainly contribute to the display. However, the polarities of the reflective display regions WR2 all become the positive polarity in a certain frame and become the negative polarity in the next frame. Accordingly, for example, a DC voltage component is applied to the pixel electrodes due to the influence of a jump voltage or the like thus giving rise to a possibility of the generation of flickers or image retention when the polarities are inverted.

Accordingly, in driving the liquid crystal display panel of the embodiment 1 or the embodiment 2, it is desirable to perform the line inversion driving in which two neighboring pixel rows constitute a set as shown in FIG. 14 (2-line inversion driving). In FIG. 14, a case in which 64 pixels are formed with 8 pixels arranged in the x direction and 8 pixels arranged in the y direction is exemplified. In FIG. 14, each square corresponds to the pixel, wherein the squares indicated by “+” are pixels to which a signal of positive polarity is applied, and the squares indicated by “−” are pixels to which a signal of negative polarity is applied. Further, in FIG. 14, L₁ (T), L₃ (T), L₅ (T), L₇ (T) are first pixel rows in which only the first pixels each having only the transmissive display region WT1 are arranged, while L₂ (T,R), L₄ (T,R), L₆ (T,R), L₈ (T,R) are second pixel rows in which the second pixels each having the reflective display region WR2 and the transmissive display region WT2 are arranged.

In performing the 2-line inversion driving of the liquid crystal display panel, for example, when a video or an image during a certain frame period is displayed, as shown in an upper side of FIG. 14, a signal of positive polarity is applied to the pixel electrodes PX of the pixels of the respective pixel rows of L₁ (T), L₂ (T,R), L₅ (T), L₆ (T,R), and a signal of negative polarity is applied to the pixel electrodes PX of the pixels of the respective pixel rows of L₃ (T), L₄ (T, R), L₇ (T), L₈ (T, R).

Then, for example, when a video or an image of a next frame period is displayed, the polarity is inverted. That is, a signal of negative polarity is applied to the pixels to which the signal of positive polarity is applied in the previous frame, and a signal of positive polarity is applied to the pixels to which the signal of negative polarity is applied in the previous frame. That is, as shown in a lower side of FIG. 14, the signal of negative polarity is applied to the pixel electrodes PX of the pixels of the respective pixel rows of L₁ (T), L₂ (T,R), L₅ (T), L₆ (T,R), and the signal of positive polarity is applied to the pixel electrodes PX of the pixels of the respective pixel rows of L₃ (T), L₄ (T,R), L₇ (T), L₈ (T,R).

Due to such 2-line inversion driving, for example, in displaying a video or an image in a certain frame period, both the polarities of two neighboring first pixel rows and the polarities of two neighboring second pixel rows take polarities opposite to each other and hence, the biasing of the polarities can be prevented. Accordingly, it is possible to prevent the generation of flickers or image retention when the polarities of the reflective display regions are inverted.

Further, in displaying a video or an image on the liquid crystal display panel, it may be possible to change over the line inversion driving shown in FIG. 13 and the 2-line inversion driving shown in FIG. 14 when necessary. As a changeover method, for example, the changeover of driving is interlocked with lighting/extinguishing of a backlight such that the line inversion driving shown in FIG. 13 is performed when the backlight is turned on and the 2-line inversion driving shown in FIG. 14 is performed when the backlight is turned off.

### Embodiment 4

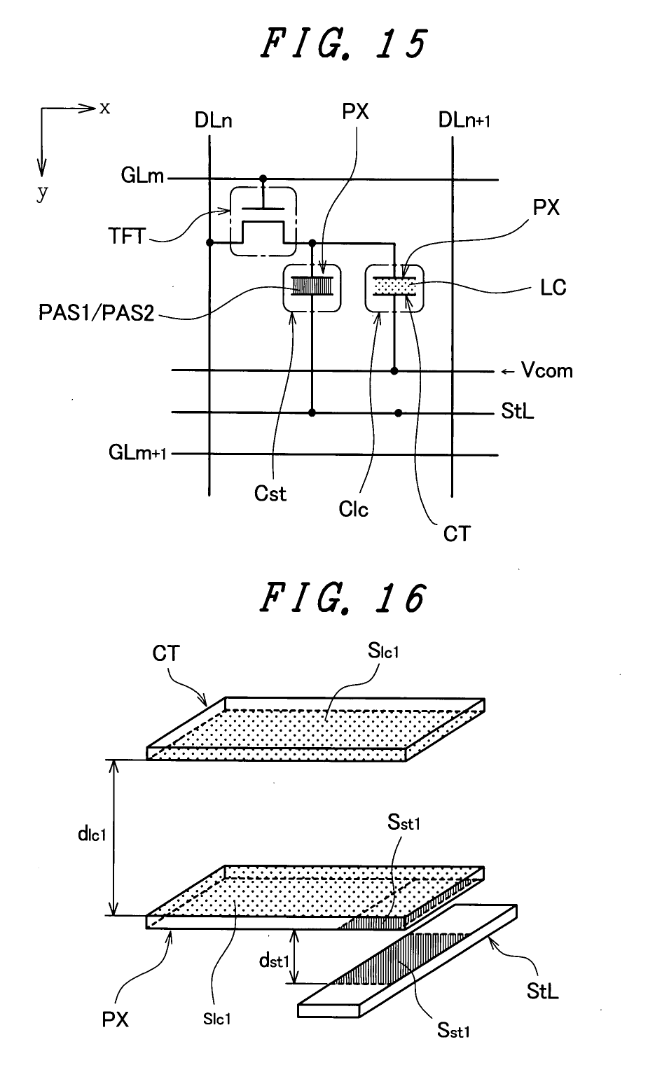

FIG. 15 is a schematic view showing the circuit constitution of one pixel of the liquid crystal display panel of the present invention.

Although the liquid crystal display panel described in the embodiment 1 or the embodiment 2 includes two kinds of pixels having constitutions different from each other, that is, the first pixels each of which includes only the transmissive display region WT1 and the second pixels each of which includes the reflective display region WR2 and the transmissive display region WT2, both pixels have the circuit constitution shown in FIG. 15. That is, a gate of a TFT element which is arranged with respect to each pixel is connected to one of a plurality of scanning signal lines GL, and a drain of the TFT element is connected to one of a plurality of video signal lines DL. Further, a source of the TFT element is connected to a pixel electrode PX arranged with respect to each pixel. Here, a liquid crystal capacitance C_{lc} is formed between a pixel electrode PX and a counter electrode CT which faces the pixel electrode PX with a liquid crystal layer LC therebetween, and a holding capacitance Cₛₜ is formed between the pixel electrode PX and a holding capacitance line StL which partially overlaps the pixel electrode PX by way of a first insulation layer PAS1 and a second insulation layer PAS2. Here, the liquid crystal capacitance C_{lc} is expressed by a following equation (1) and the holding capacitance Cₛₜ is expressed by a following equation (2). Here, a pixel capacitance Cₚᵢₓ of each pixel is expressed as a combined capacitance of the liquid crystal capacitance C_{lc} and the holding capacitance Cₛₜ as shown in the following equation (3).

C_{lc}=∈₀·∈_{lc}(S_{lc}/d_{lc}) (equation 1)

Cₛₜ=∈₀·∈ₛₜ(Sₛₜ/dₛₜ) (equation 2)

1/Cₚᵢₓ=1/C_{lc}+1/Cₛₜ (equation 3)

Here, in the equations (1) and (2), ∈₀ is a dielectric constant in a vacuum. Further, in the equation (1), ∈_{lc} is a relative dielectric constant of liquid crystal layer LC, S_{lc} is an area of a liquid crystal layer LC when viewed in a plan view, and d_{lc} is a thickness of the liquid crystal layer LC. Further, in the equation (2), ∈ₛₜ is a relative dielectric constant of an insulation layer PAS between the pixel electrode PX and the holding capacitance line StL, Sₛₜ is an area of the insulation layer PAS when viewed in a plan view, and dₛₜ is a thickness of the insulation layer PAS.

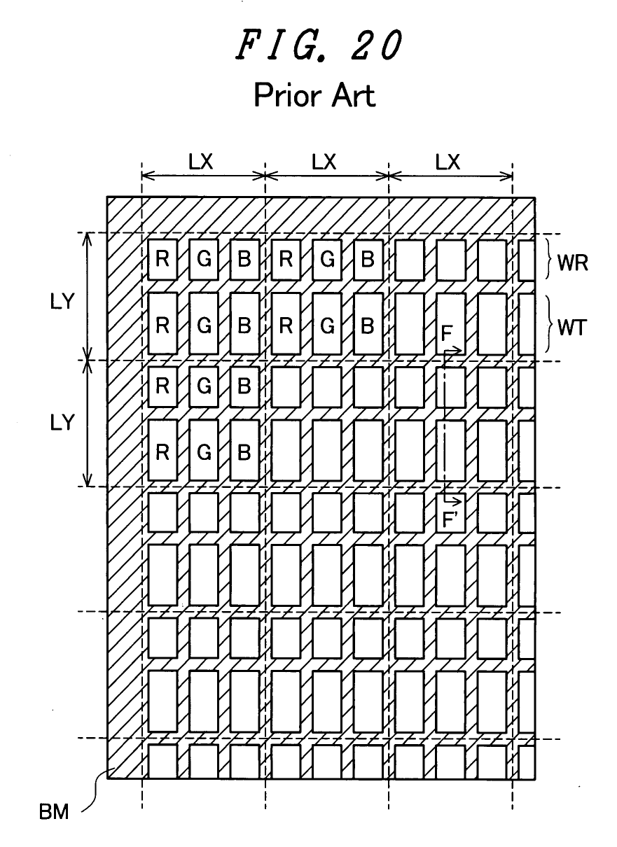

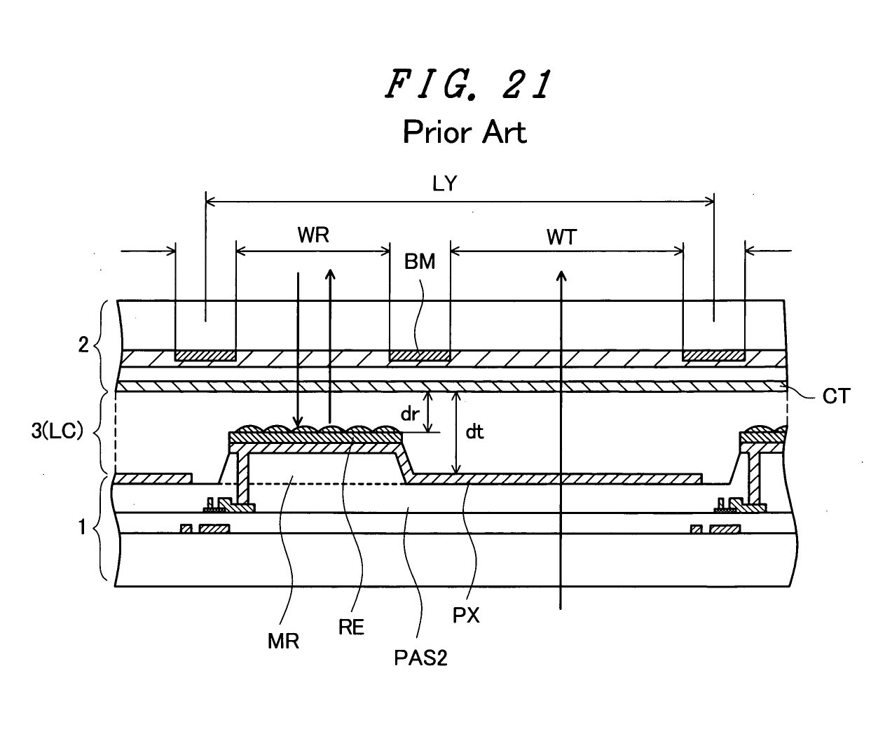

In the conventional transflective liquid crystal display panel, for example, as shown in FIG. 20 and FIG. 21, the respective pixels (sub pixels) have the same constitution and the pixel electrodes PX also have the same shape. Accordingly, the respective pixels have the same liquid crystal capacitance and hence, it is possible to set the pixel capacitances of the respective pixels to a fixed value by fixing the holding capacitances of the respective pixels to a fixed value.

However, in the liquid crystal display panel of the embodiment 1 or the embodiment 2, the pixel electrode PX of the sub pixel of the first pixel and the pixel electrode PX of the sub pixel of the second pixel differ from each other in shape and hence, usually, a value of the liquid crystal capacitance C_{lc1} of the first pixel and a value of the liquid crystal capacitance C_{lc2} of the second pixel differ from each other. Accordingly, when the holding capacitances of the respective pixels are set to a fixed value as in the case of the conventional transflective liquid crystal display panel, the pixel capacitance of the first pixel and the pixel capacitance of the second pixel which are expressed by the equation (3) assume values different from each other thus giving rise to a high possibility that the display irregularities occur.

To overcome such a drawback, in the liquid crystal display panel of the embodiment 1 or the embodiment 2, it is desirable to change the values of the holding capacitance Cₛₜ₁ of the first pixel and the holding capacitance Cₛₜ₂ of the second pixel based on the difference between the liquid crystal capacitance C_{lc1} of the first pixel and the liquid crystal capacitance C_{lc2} of the second pixel such that the pixel capacitance Cₚᵢₓ₁ of the first pixel and the pixel capacitance Cₚᵢₓ₂ of the second pixel become substantially equal to each other.

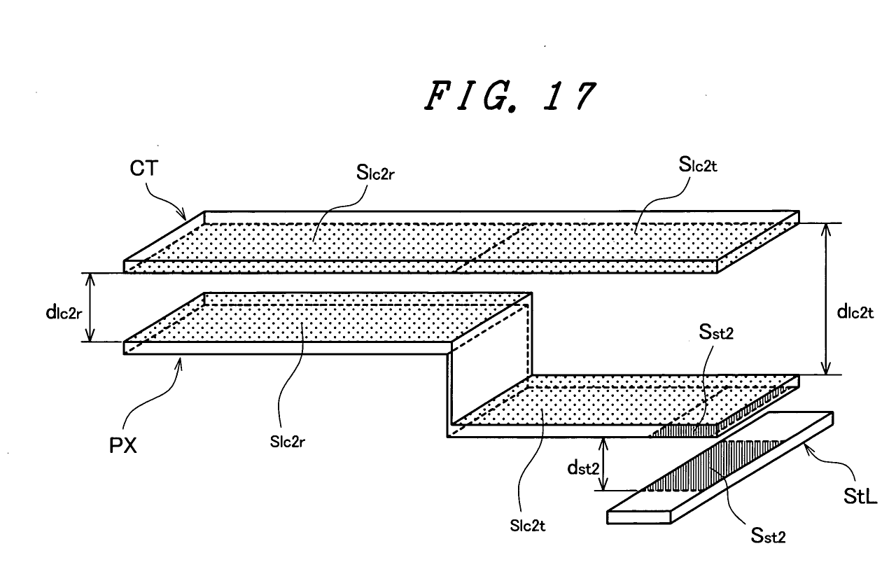

FIG. 16 is a schematic view for explaining the manner of acquiring the pixel capacitance of the first pixel of the liquid crystal display panel of the present invention. FIG. 17 is a schematic view for explaining the manner of acquiring the pixel capacitance of the second pixel of the liquid crystal display panel of the present invention.

With respect to the pixel having only the transmissive display region WT1 such as the first pixel, to schematically explain by taking out the pixel electrode PX, the common electrode CT and the holding capacitance line StL which are relevant to the formation of the liquid crystal capacitance C_{lc1} and the holding capacitance Cₛₜ₁, the relationship shown in FIG. 16 is established. Here, assume that the pixel electrode PX and the common electrode CT are arranged parallel to each other, the thickness of the liquid crystal layer LC which is interposed between both electrodes is set as d_{lc1}, and the area of a region where both electrodes overlap each other in a plan view (area of the liquid crystal layer LC interposed between both electrodes as viewed in a plan view) is set as S_{lc1}. Further, assume that the pixel electrode PX and the holding capacitance line StL are arranged parallel to each other, the thickness of the insulation layer PAS which is interposed between the pixel electrode PX and the holding capacitance line StL is set as dₛₜ₁, and the area of a region where the pixel electrode PX and the holding capacitance line StL overlap each other in a plan view is set as Sₛₜ₁. Still further, assume that the dielectric constant in a vacuum is ∈₀, the relative dielectric constant of the liquid crystal layer LC as ∈_{lc}, and the relative dielectric constant of the insulation layer interposed between the pixel electrode PX and the holding capacitance line StL as ∈ₛₜ, the liquid crystal capacitance C_{lc1}, the holding capacitance Cₛₜ₁ and the pixel capacitance Cₚᵢₓ₁ are respectively expressed by following equations (4) to (6).

C_{lc1}=∈₀·∈_{lc}(S_{lc1}/d_{lc1}) (equation 4)

Cₛₜ₁=∈₀·∈ₛₜ(Sₛₜ₁/dₛₜ₁) (equation 5)

1/Cₚᵢₓ=1/C_{lc1}+1/Cₛₜ₁ (equation 6)

Further, with respect to the pixel having the reflective display region WR2 and the transmissive display region WT2 such as the second pixel, to schematically explain by taking out the pixel electrode PX, the common electrode CT and the holding capacitance line StL which are relevant to the formation of the liquid crystal capacitance C_{lc2} and the holding capacitance Cₛₜ₂, the relationship shown in FIG. 17 is established. Here, assume that the pixel electrode PX and the common electrode CT are arranged parallel to each other in the reflective display region WR2 and the transmissive display region WT2, and a distance between the pixel electrode PX and the common electrode CT in the reflective display region WR2 is set shorter than a distance between the pixel electrode PX and the common electrode CT in the transmissive display region WT2. Further, with respect to the thickness of the liquid crystal layer LC which is interposed between both electrodes, the thickness of the liquid crystal layer LC in the reflective display region WR2 is set as d_{lc2r} and the thickness of the liquid crystal layer LC in the transmissive display region WT2 is set as d_{lc2t}. Further, with respect to the area of a region where both electrodes overlap each other in a plan view (area of the liquid crystal layer LC interposed between both electrodes as viewed in a plan view), the area of a region where both electrodes overlap each other in the reflective display region WR2 is set as S_{lc2r} and the area of a region where both electrodes overlap each other in the transmissive display region WT2 is set as S_{lc2t}. Further, assume that the pixel electrode PX and the holding capacitance line StL are arranged parallel to each other, the thickness of the insulation layer PAS which is interposed between the pixel electrode PX and the holding capacitance line StL is set as dₛₜ₂, and the area of a region where the pixel electrode PX and the holding capacitance line StL overlap each other in a plan view is set as Sₛₜ₂. Here, assume that the holding capacitance line StL overlaps the pixel electrode PX in the transmissive display region WT2 as viewed in a plan view. Still further, assume that the dielectric constant in a vacuum is ∈₀, the relative dielectric constant of the liquid crystal layer LC is ∈_{lc}, and the relative dielectric constant of the insulation layer PAS interposed between the pixel electrode PX and the holding capacitance line StL is ∈ₛₜ, the liquid crystal capacitance C_{lc2r} in the reflective display region WR2, the liquid crystal capacitance C_{lc2t} in the transmissive display region WT2, the liquid crystal capacitance C_{lc2} of the sub pixel of the second pixel, the holding capacitance Cₛₜ₂ and the pixel capacitance Cₚᵢₓ₂ in the sub pixel of the second pixel are respectively expressed by following equations (7) to (11).

C_{lc2r}=∈₀·∈_{lc}(S_{lc2r}/d_{lc2r}) (equation 7)

C_{lc2t}=∈₀·∈_{lc}(S_{lc2t}/d_{lc2t}) (equation 8)

C_{lc2}=C_{lc2r}+C_{lc2t} (equation 9)

Cₛₜ₂=∈₀·∈ₛₜ(Sₛₜ₂/dₛₜ₂) (equation 10)

1/Cₚᵢₓ₂=1/C_{lc2}+1/Cₛₜ₂ (equation 11)

In the liquid crystal display panel of the embodiment 1 or the embodiment 2, the liquid crystal capacitance C_{lc1} of the first pixel and the liquid crystal capacitance C_{lc2} of the second pixel are determined based on the size of the pixel of the liquid crystal display panel and the thickness of the liquid crystal layer LC and hence, it is difficult to obtain the relationship Cₚᵢₓ₁≈Cₚᵢₓ₂ by adjusting these liquid crystal capacitances. Accordingly, to obtain the relationship Cₚᵢₓ₁≈Cₚᵢₓ₂, it is desirable to adjust the values of the holding capacitance Cₛₜ₁ of the first pixel and the holding capacitance Cₛₜ₂ of the second pixel. Although various methods are considered to change values of the holding capacitance Cₛₜ₁ of the first pixel and the holding capacitance Cₛₜ₂ of the second pixel, the easiest way is to change an overlapping area of the pixel electrode PX and the holding capacitance line StL as viewed in a plan view. To change an overlapping area of the pixel electrode PX and the holding capacitance line StL as viewed in a plan view, the size of the pixel electrode PX or the size (width) of the holding capacitance line StL may be changed.

In this manner, by adjusting the values of the holding capacitance Cₛₜ₁ of the first pixel and the holding capacitance Cₛₜ₂ of the second pixel for making the pixel capacitance Cₚᵢₓ₁ of the first pixel and the pixel capacitance Cₚᵢₓ₂ of the second pixel substantially equal to each other, it is possible to prevent the irregularities of image quality attributed to the fluctuation of the pixel capacitance, for example.

Here, in the embodiment 4, the case in which the holding capacitance is formed between the holding capacitance line StL arranged in parallel to the scanning signal line GL and the pixel electrode PX is exemplified. However, it is needless to say that this embodiment is not limited to such a case and the holding capacitance may be formed between the scanning signal line GL and the pixel electrode PX. In this case, by changing an area of a region where the scanning signal line GL and the pixel electrode PX overlap each other in a plan view, the values of the holding capacitance Cₛₜ₁ of the first pixel and the holding capacitance Cₛₜ₂ of the second pixel may be adjusted.

Although the present invention has been explained specifically based on the embodiments, it is needless to say that the present invention is not limited to the above-mentioned embodiments and various modifications are conceivable without departing from the gist of the present invention.

For example, in the liquid crystal display panel of the embodiment 1 or the embodiment 2, the first pixel row in which the first pixels are arranged in the x direction and the second pixel row in which the second pixels are arranged in the x direction are alternately arranged in the y direction. However, the liquid crystal display panel of the present invention is not limited to such arrangement of the pixels. For example, to focus on a plurality of pixels which are arranged in the certain direction, even when the first pixel and the second pixel are alternately arranged, it is considered that the liquid crystal display panel of the present invention can obtain the substantially equal advantageous effects. Hereinafter, modifications of the liquid crystal display panel of the present invention on the arrangement of the first pixels and the second pixels is simply explained.

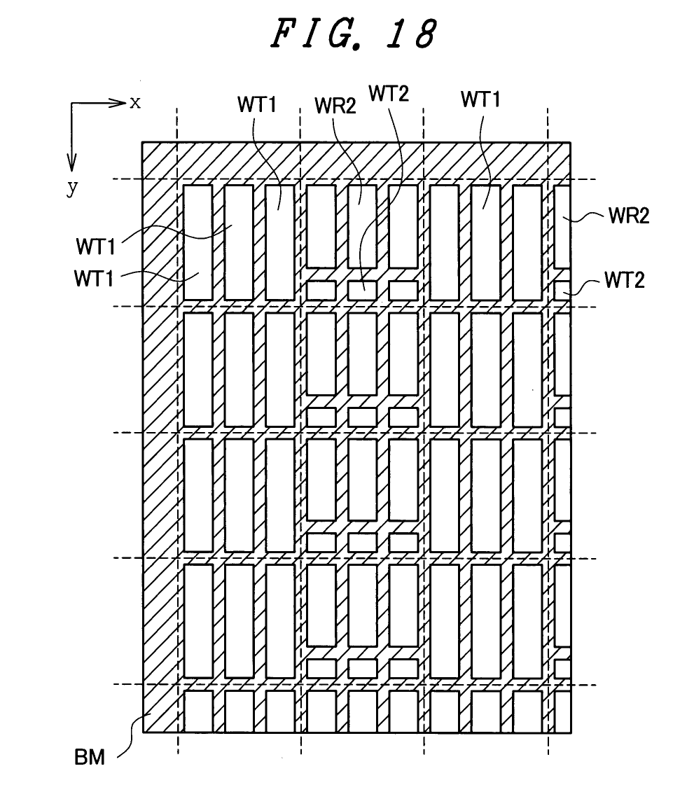

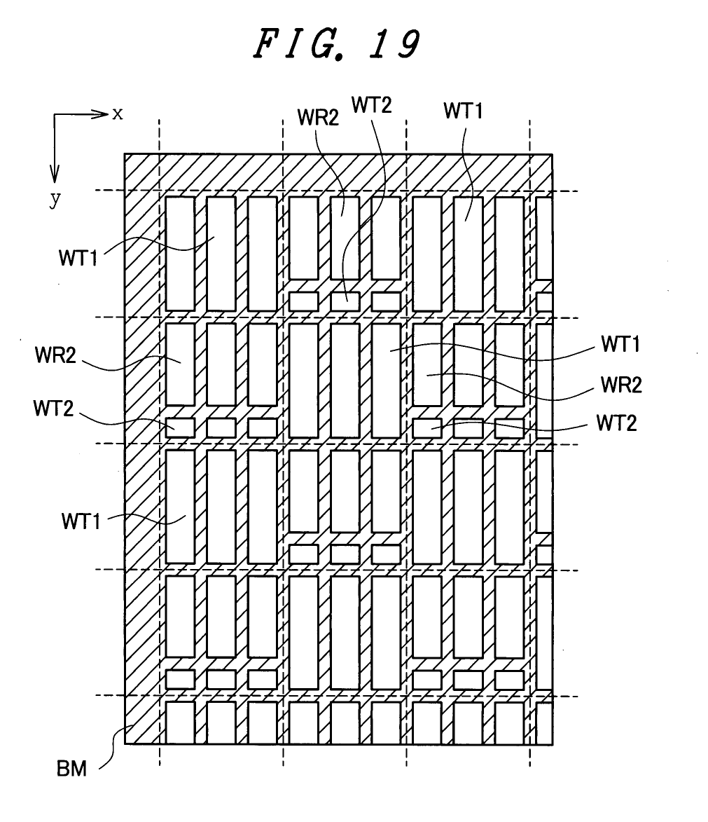

FIG. 18 is a schematic plan view for explaining the first modification of the liquid crystal display panel according to the present invention. FIG. 19 is a schematic plan view for explaining the second modification of liquid crystal display panel according to the present invention. Here, FIG. 18 and FIG. 19 are schematic plan views which describe a region AR1 shown in FIG. 1 in an enlarged manner.

In the liquid crystal display panel of the embodiment 1 or the embodiment 2, the first pixel row in which the first pixels are arranged in the x direction and the second pixel row in which the second pixels are arranged in the x direction are alternately arranged in the y direction. Further, in the embodiment 1 and the embodiment 2, the extending directions of the scanning signal lines GL and the holding capacitance lines StL are arranged in the x direction and the extending direction of the video signal lines DL is arranged in the y direction. However, an essential point of the display panel of this embodiment lies in that to focus on two neighboring pixels, one pixel is constituted of a pixel which has only the transmissive display region and another pixel is constituted of the pixel which has the reflective display region and the transmissive display region. Due to such a constitution, for example, it is possible to increase the display quality of the reflective display region compared to the display quality of the reflective display region of the conventional liquid crystal display panel while allowing the transmissive display region to maintain the display quality substantially equal to the display quality of the transmissive display region of the conventional transflective liquid crystal display panel.

Accordingly, in the liquid crystal display panel of the present invention, for example, as shown in FIG. 18, the first pixel row in which a plurality of first pixels are arranged in the y direction and the second pixel row in which a plurality of second pixels are arranged in the y direction may be alternately arranged in the x direction. Here, it is desirable that both the first pixel and the second pixel have a size LX in the x direction and a size LY in the y direction. In this case, the x direction is the extending direction of the scanning signal line GL and the holding capacitance line StL, and they direction is the extending direction of the video signal line DL. Also in the arrangement shown in FIG. 18, to focus on two neighboring pixels in the x direction, the combination of the first pixel which has only the transmissive display region and the second pixel which has the reflective display region and the transmissive display region is provided and hence, the liquid crystal display panel of this modification is considered to obtain the substantial equal advantageous effects as the liquid crystal display panel of the embodiment 1 or the embodiment 2.

Further, in the liquid crystal display panel of the embodiment 1 or the embodiment 2, or the liquid crystal display panel shown in FIG. 18, to focus on two neighboring pixels in either one of the x direction or they direction, the combination of the first pixel and the second pixel is provided, while to focus on two neighboring pixels in another direction, the combination of the first pixels or the combination of the second pixels is provided. However, the present invention is not limited to such arrangement. For example, as shown in FIG. 19, the first pixel and the second pixel may be arranged in a staggered manner.

In case of the liquid crystal display panel shown in FIG. 19, to focus on a plurality of pixels which are arranged in the x direction, the fist pixel and the second pixel are alternately arranged. Further, also to focus on a plurality of pixels arranged in the y direction, the first pixel and the second pixel are alternately arranged. In this manner, also to focus on two neighboring pixels, in either one of the x direction or the y direction, the arrangement which adopts the combination of the first pixel and the second pixel is considered to obtain the substantially equal advantageous effects as the liquid crystal display panel of the embodiment 1 or the embodiment 2.

What is claimed is:

1. A liquid crystal display device including a liquid crystal display panel which seals a liquid crystal material between a pair of substrates, the liquid crystal display panel having a display region which is constituted of a plurality of pixels arranged two-dimensionally in the extending direction of scanning signal lines and in the extending direction of video signal lines, wherein
the display region of the liquid crystal display panel alternately arranges a first pixel row and a second pixel row thereon in the extending direction of the video signal lines, the first pixel row arranging a plurality of first pixels each of which includes only a transmissive display region which radiates light incident on the liquid crystal display panel from a back side of the liquid crystal display panel as viewed from a viewer to a viewer side in parallel in the extending direction of the scanning signal lines, and the second pixel row arranging a plurality of second pixels each of which includes a reflective display region which radiates light incident on the liquid crystal display panel from a front side of the liquid crystal display panel and the transmissive display region in parallel in the extending direction of the scanning signal lines.

2. A liquid crystal display device according to claim 1, wherein the second pixel is configured such that the reflective display region and the transmissive display region are arranged in parallel in the extending direction of the video signal lines.

3. A liquid crystal display device according to claim 1, wherein a size of the second pixel in the extending direction of the video signal lines is larger than a size of the first pixel in the extending direction of the video signal lines.

4. A liquid crystal display device according to claim 1, wherein an area of the transmissive display region of the first pixel is approximately equal to an area of the transmissive display region of the second pixel.

5. A liquid crystal display device according to claim 1, wherein a size of the second pixel in the extending direction of the video signal lines is equal to a size of the first pixel in the extending direction of the video signal lines.

6. A liquid crystal display device according to claim 1, wherein an area of the transmissive display region of the first pixel differs from an area of the transmissive display region of the second pixel.

7. A liquid crystal display device according to claim 1, wherein a thickness of the liquid crystal material in the reflective display region is smaller than a thickness of the liquid crystal material in the transmissive display region.

8. A liquid crystal display device according to claim 1, wherein the liquid crystal display panel includes the scanning signal lines, the video signal lines, and pixel electrodes which are arranged with respect to the plurality of respective pixels on one substrate out of the pair of substrates, the pixel electrode includes a region which overlaps the scanning signal line as viewed in a plan view, and an area of the region where the pixel electrode overlaps the scanning signal line arranged with respect to the first pixel and an area of the region where the pixel electrode overlaps the scanning signal line arranged with respect to the second pixel differ from each other.

9. A liquid crystal display device according to claim 1, wherein the liquid crystal display panel includes the scanning signal lines, the video signal lines, pixel electrodes which are arranged with respect to the plurality of respective pixels, and holding capacitance lines which are arranged in parallel to the scanning signal lines on one substrate out of the pair of substrates, the pixel electrode includes a region which overlaps the holding capacitance line as viewed in a plan view, and an area of the region where the pixel electrode overlaps the holding capacitance line arranged with respect to the first pixel and an area of the region where the pixel electrode overlaps the holding capacitance line of the pixel electrode arranged with respect to the second pixel differ from each other.

10. A liquid crystal display device according to claim 1, wherein a signal of positive polarity and a signal of negative polarity with respect to a potential of a common electrode are alternately applied to the pixel electrodes of respective pixels of the liquid crystal display panel for every other preset number of frames,
the signal having the same polarity as the polarity with respect to the potential of the common electrode is applied to the pixel electrodes of the respective pixels of two neighboring pixel rows in one frame, and
the polarity of the signal which is applied to the pixel electrodes of respective pixels of two pixel rows with respect to the potential of the common electrode is a polarity opposite to polarity of a signal which is applied to the pixel electrodes of respective pixels of two other pixel rows adjacent to two pixel rows with respect to the potential of the common electrode.

11. A liquid crystal display device including a liquid crystal display panel which seals a liquid crystal material between a pair of substrates, the liquid crystal display panel having a display region which is constituted of a plurality of pixels arranged two-dimensionally in the extending direction of scanning signal lines and in the extending direction of video signal lines, wherein
the display region of the liquid crystal display panel is configured such that a plurality of pixel rows each of which arranges a first pixel having only a transmissive display region and a second pixel having a reflective display region and a transmissive display region alternately in parallel in the extending direction of the scanning signal lines is arranged in the extending direction of the video signal lines.

12. A liquid crystal display device according to claim 11, wherein the plurality of pixels which is arranged in parallel in the extending direction of the video signal lines in the display region of the liquid crystal display panel is constituted of only the first pixel or only the second pixel which is arranged in parallel.

13. A liquid crystal display device according to claim 11, wherein the plurality of pixels which is arranged in parallel in the extending direction of the video signal lines in the display region of the liquid crystal display panel is constituted of the first pixel and the second pixel which are alternatively arranged in parallel with each other.

14. A liquid crystal display device according to claim 11, wherein the second pixel is configured such that the reflective display region and the transmissive display region are arranged in parallel in the extending direction of the video signal lines.

15. A liquid crystal display device according to claim 11, wherein a thickness of the liquid crystal material in the reflective display region is smaller than a thickness of the liquid crystal material in the transmissive display region.

16. A liquid crystal display device according to claim 11, wherein the liquid crystal display panel includes the scanning signal lines, the video signal lines, and pixel electrodes which are arranged with respect to the plurality of respective pixels on one substrate out of the pair of substrates, the pixel electrode includes a region which overlaps the scanning signal line as viewed in a plan view, and an area of the region where the pixel electrode overlaps the scanning signal line arranged with respect to the first pixel and an area of the region where the pixel electrode overlaps the scanning signal line arranged with respect to the second pixel differ from each other.

17. A liquid crystal display device according to claim 11, wherein the liquid crystal display panel includes the scanning signal lines, the video signal lines, pixel electrodes which are arranged with respect to the plurality of respective pixels, and holding capacitance lines which are arranged in parallel to the scanning signal lines on one substrate out of the pair of substrates, the pixel electrode includes a region which overlaps the holding capacitance line as viewed in a plan view, and an area of the region where the pixel electrode overlaps the holding capacitance line arranged with respect to the first pixel and an area of the region where the pixel electrode overlaps the holding capacitance line arranged with respect to the second pixel differ from each other.
